(19) United States
(12) Patent Application Publication
(10) Pub. No.: US 2026/0110905 A1
(43) Pub. Date: Apr. 23, 2026

(54) SPACERS FOR WAVEGUIDE STACKS IN OPTICAL DEVICES

(71) Applicant: Magic Leap, Inc., Plantation, FL (US)

(72) Inventors: Marlon Edward MENEZES, Austin, TX (US); Vikramjit SINGH, Pflugerville, TX (US); Frank Y XU, Austin, TX (US)

(21) Appl. No.: 19/117,688

(22) PCT Filed: Oct. 14, 2022
(86) PCT No.: PCT/US2022/078152

§ 371 Date: Apr. 2, 2025

(51) Int. Cl. G02B 27/01

(52) U.S. Cl. CPC G02B 27/0172; G02B 2027/0112

(57) ABSTRACT

This disclosure describes techniques for manufacturing waveguides that include spacer(s) on at least one surface of the waveguide, such that the spacers maintain mechanical stability and separation between the waveguides when the waveguides as assembled into a waveguide stack that is usable as an optical device. The disclosure also describes the various implementations of waveguides and optical devices that include spacers. The spacers may be created using a drop dispenser, in which drops of a (e.g., polymer) fluid are dispensed onto at least one surface of a substrate to be used as a waveguide. After being dispensed, the fluid drops can be cured to create the final, solidified spacers. Curing may also be performed in-flight before the drops reach the surface of the substrate. Partially cured drops may be stacked to create spacers of a particular height.

### TECHNICAL FIELD

This disclosure relates to display systems and, more particularly, to display systems for augmented reality, virtual reality, and/or mixed reality.

### BACKGROUND

Modern computing and display technologies have facilitated the development of systems for virtual reality, augmented reality, and mixed reality experiences, wherein digitally generated content (e.g., images, graphics, etc.) are presented to a user in a manner such that the presented content may be perceived as real. A virtual reality system typically presents digital (e.g., virtual) content without also enabling the user to view the actual, real-world environment. An augmented reality system can present digital content while also enabling the user to view the actual real-world environment in proximity to the user, such that the digital content augments the visualization of the environment in proximity to the user. A mixed reality system is a type of augmented reality system in which the virtual content can be integrated into, and/or responsive to, physical objects in the real-world environment. For example, in a mixed reality scenario, augmented reality digital content may appear to be interacting with physical objects, existing on top of physical objects, behind or in front of physical objects, and so forth.

Referring to FIG. 1, an augmented reality scene 10 is depicted wherein a user of an augmented reality system sees a real-world park-like setting 20 featuring people, trees, buildings in the background, and a concrete platform 30. In addition to these items, the user of the augmented reality system is also shown virtual content such as a robot statue 40 standing upon the real-world platform 30, and a cartoon-like avatar character 50 flying by which appears as a bumble bee, even though these elements 40, 50 are not physical objects in the real world. Because the human visual perception system is complex, it is challenging to produce augmented reality technology that provides a comfortable, natural-feeling, rich presentation of virtual content that appears to be naturally existing in the midst of other virtual or real-world elements. The systems and methods disclosed herein address various challenges related to augmented reality, virtual reality, and/or mixed reality technology.

### SUMMARY

This disclosure generally describes techniques for manufacturing a waveguide that includes one or more spacers on at least one surface of the waveguide, such that the spacers maintain a desired separation between the waveguides when the waveguides as assembled into a waveguide stack that is usable as an optical device. The disclosure also describes the various implementations of waveguides and optical devices that include spacers. In some implementations, the optical device including the spacer-separated waveguide stack is a component of a wearable (e.g., head mountable) or other type of system that provides an augmented reality (AR), virtual reality (VR), or mixed reality (MR) experience.

The spacers may be created using a drop dispenser, in which drops of a fluid (e.g., a prepolymer material) are dispensed onto at least one surface of a substrate to be used as a waveguide. After being dispensed, the fluid drops can be cured to create the final, solidified spacers. In some instances, the fluid drops may be allowed to flow for a predetermined amount of time prior to curing, to create spacers with a particular shape and/or height. In some implementations, the spacer drops may be placed on areas of the substrate that are optically active areas, such as areas that have previously been imprinted with a diffraction grating or other structures. The spacer drops may also be placed outside of active areas. In some implementations, confinement gratings may be created on various locations on the surface of the substrate where spacer drops are to be placed, to more precisely control the flow of the spacer fluid on the surface prior to curing. In some implementations, the spacer drops may be cured in-flight while the drops are falling toward the surface of the substrate, such as the drops are at least partly cured before they reach the surface. In this way, cured drops of the fluid can operate as spacers. Also, in instances when the drops are partly cured in-flight, multiple drops can be stacked to create spacers of a desired height.
Embodiment 1 is a waveguide stack for use in an optical device, the waveguide stack comprising:
   a first waveguide configured to convey first light through total internal reflection (TIR); and
   a second waveguide configured to convey second light through TIR, wherein the second waveguide includes, on at least one surface of the second waveguide, a plurality of spacers composed of a polymer material that has been dispensed onto the at least one surface and cured, wherein the plurality of spacers are arranged on the at least one surface such that the plurality of spacers are between the second waveguide and the first waveguide in the waveguide stack, and wherein the plurality of spacers each have a respective size to maintain a predetermined separation between the first waveguide and the second waveguide in the waveguide stack.
Embodiment 2 is the waveguide stack of embodiment 1, wherein the second light has a range of wavelengths, and wherein the plurality of spacers are composed of a material that absorbs the second light having the range of wavelengths.
Embodiment 3 is the waveguide stack of embodiment 1 or 2, wherein the plurality of spacers are composed of a material that is black.
Embodiment 4 is the waveguide stack of any one of embodiments 1-3, wherein the plurality of spacers each have a diameter in a range of 10 microns to 200 microns.
Embodiment 5 is the waveguide stack of any one of embodiments 1-4, wherein the predetermined separation is in a range of 30 microns to 50 microns or 35 microns to 45 microns.
Embodiment 6 is the waveguide stack of any one of embodiments 1-5, wherein the plurality of spacers inhibits direct contact between the first waveguide and the second waveguide.
Embodiment 7 is the waveguide stack of any one of embodiments 1-6, wherein the first waveguide and the second waveguide are composed of a glass.
Embodiment 8 is the waveguide stack of any one of embodiments 1-7, wherein the first waveguide and the second waveguide are composed of a polymer material.
Embodiment 9 is the waveguide stack of any one of embodiments 1-8, wherein the plurality of spacers are composed of a polymer material.
Embodiment 10 is the waveguide stack of any one of embodiments 1-9, wherein the polymer material comprises a dye or pigment selected to absorb all or a portion of light in the visible region.
Embodiment 11 is the waveguide stack of any one of embodiments 1-10, wherein the polymer material comprises inorganic nanoparticles.
Embodiment 12 is the waveguide stack of embodiment 11, wherein a diameter of the inorganic nanoparticles is less than 10 nm.
Embodiment 13 is the waveguide stack of embodiment 11, wherein the inorganic nanoparticles comprise ZrO₂ or TiO₂.
Embodiment 14 is the waveguide stack of any one of embodiments 1-13, wherein the polymer material comprises a refractive index of at least 2 at a wavelength of 532 nm.
Embodiment 15 is the waveguide stack of any one of embodiments 1-14, wherein the second waveguide includes, on at least one surface of the second waveguide, one or more optically active regions, and wherein at least one of the plurality of spacers is located in the one or more optically active regions.
Embodiment 16 is the waveguide stack of any one of embodiments 1-15, wherein the one or more optically active regions include one or more of an exit pupil expander (EPE), an orthogonal pupil expander (OPE), a combined pupil expander (CPE), or an in-coupling grating (ICG).
Embodiment 17 is the waveguide stack of any one of embodiments 1-16, wherein the first and second waveguides are transparent.
Embodiment 18 is the waveguide stack of any one of embodiments 1-17, wherein the second waveguide includes, on at least one surface of the second waveguide, at least one confinement region bounded by one or more confinement gratings, and wherein at least one of the plurality of spacers is located in the at least one confinement region.
Embodiment 19 is the waveguide stack of any one of embodiments 1-18, wherein the first and second waveguides are flat.
Embodiment 20 is the waveguide stack of any one of embodiments 1-19, wherein the first and second waveguides are curved.
Embodiment 21 is the waveguide stack of any one of embodiments 1-20, further comprising a third waveguide configured to convey third light through TIR, wherein the first light has a first range of wavelengths, wherein the second light has a second range of wavelengths different than the first range, and wherein the third light has a third range of wavelengths different than the first range and the second range.
Embodiment 22 is the waveguide stack of embodiment 21, wherein the first range, the second range, and the third range each corresponds to a different one of red light, green light, and blue light.
Embodiment 23 is the waveguide stack of embodiment 21 or 22, wherein the third waveguide includes, on at least one second surface of the third waveguide, a second plurality of spacers composed of the polymer material that has been dispensed onto the at least one second surface and cured, wherein the second plurality of spacers are arranged on the at least one second surface such that the second plurality of spacers are between the third waveguide and the second waveguide in the waveguide stack, and wherein the second plurality of spacers each have a respective size to maintain a predetermined separation between the second waveguide and the third waveguide in the waveguide stack.
Embodiment 24 is the waveguide stack of any one of embodiments 1-23, wherein at least one of the plurality of spacers is substantially spherical and cured prior to being placed on the at least one surface.
Embodiment 25 is the waveguide stack of any one of embodiments 1-24, wherein at least one of the plurality of spacers is partially cured prior to being placed on the at least one surface.
Embodiment 26 is the waveguide stack of embodiment 25, wherein the at least one of the plurality of spacers is finally cured after being placed on the at least one surface.
Embodiment 27 is the waveguide stack of any one of embodiments 1-26, wherein the plurality of spacers includes at least one spacer that is composed of at least two stacked drops of the polymer material, including a first drop that is partially cured prior to being placed on the at least one surface, and a second drop that is partially cured prior to being placed on top of the first drop.
Embodiment 28 is the waveguide stack of any one of embodiments 1-27, wherein at least two of the plurality of spacers have different sizes.
Embodiment 29 is the waveguide stack of any one of embodiments 1-28, wherein the polymer material of at least one of the plurality of spacers flows for a period of time after the polymer material is placed on the at least one surface and before the polymer material is cured.
Embodiment 30 is a method of manufacturing a waveguide stack for use in an optical device, the method comprising:
   dispensing a plurality of drops of a prepolymer material onto at least one surface of a first waveguide;
   curing the drops to form a plurality of spacers from the plurality of drops; and
   stacking the first waveguide with a second waveguide to assemble the waveguide stack,
      wherein the plurality of spacers are arranged on the at least one surface such that the plurality of spacers are between the second waveguide and the first waveguide in the waveguide stack, and wherein the plurality of spacers each have a respective size to maintain a predetermined separation between the first waveguide and the second waveguide in the waveguide stack.
Embodiment 31 is the method of embodiment 30, wherein the plurality of drops are dispensed from a drop dispenser, and wherein the drops are fully cured after they exit the drop dispenser and before the drops reach the at least one surface.
Embodiment 32 is the method embodiment 30 or 31, wherein the plurality of drops are dispensed from a drop dispenser, and wherein the drops are partially cured after they exit the drop dispenser and before the drops reach the at least one surface.
Embodiment 33 is the method of any one of embodiments 30-32, wherein the plurality of drops are dispensed from a drop dispenser, and wherein curing the drops comprises:
   a first curing in which the drops are partially cured after they exit the drop dispenser and before they reach the at least one surface; and
   a second curing in which the drops are fully cured after the drops reach the at least one surface.
Embodiment 34 is the method of any one of embodiments 30-33, wherein the prepolymer material comprises a dye or pigment selected to absorb all or a portion of light in the visible region.
Embodiment 35 is the method of any one of embodiments 30-34, wherein the prepolymer material has a refractive index in a range of about 1.5 to about 1.75 at a wavelength of 532 nm.
Embodiment 36 is the method of any one of embodiments 30-35, wherein the prepolymer material comprises inorganic nanoparticles.
Embodiment 37 is the method of embodiment 36, wherein a diameter of the inorganic nanoparticles is less than 10 nm.
Embodiment 38 is the method of embodiment 36 or 37, wherein the inorganic nanoparticles comprise ZrO₂ or TiO₂.
Embodiment 39 is the method of any one of embodiments 30-38, wherein each spacer of the plurality of spacers comprises a refractive index of at least 2 at a wavelength of 532 nm.

Other features and advantages are apparent from the following detailed description and figures, and from the claims.

### BRIEF DESCRIPTION OF THE DRAWINGS

FIG. 1 illustrates a user's view of augmented reality or mixed reality through an augmented reality or mixed reality device.

FIG. 2 illustrates a conventional display system for simulating three-dimensional imagery for a user.

FIGS. 3A-3C illustrate relationships between radius of curvature and focal radius.

FIG. 4A illustrates a representation of the accommodation-vergence response of the human visual system.

FIG. 4B illustrates examples of different accommodative states and vergence states of a pair of eyes of the user.

FIG. 4C illustrates an example of a representation of a top-down view of a user viewing content via a display system.

FIG. 4D illustrates another example of a representation of a top-down view of a user viewing content via a display system.

FIG. 5 illustrates aspects of an approach for simulating three-dimensional imagery by modifying wavefront divergence.

FIG. 6 illustrates an example of a waveguide stack for outputting image information to a user.

FIG. 7 illustrates an example of exit beams outputted by a waveguide.

FIG. 8 illustrates an example of a stacked waveguide assembly in which each depth plane includes images formed using multiple different component colors.

FIG. 9A illustrates a cross-sectional side view of an example of a set of stacked waveguides that each includes an incoupling optical element.

FIG. 9B illustrates a perspective view of an example of the plurality of stacked waveguides of FIG. 9A.

FIG. 9C illustrates a top-down plan view of an example of the plurality of stacked waveguides of FIGS. 9A and 9B.

FIG. 9D illustrates an example of wearable display system.

FIG. 10 illustrates an example system for manufacturing waveguides or other types of optical devices.

FIG. 11A illustrates an example schematic of a waveguide stack.

FIG. 11B illustrates an example schematic of a waveguide stack with spacers.

FIGS. 12A and 12B are test images illustrating performance of an optical device with different spacer configurations.

FIG. 13 is a graph illustrating performance of an optical device with different spacer configurations.

FIG. 14 illustrates example schematics of a substrate with dispensed spacer material.

FIGS. 15A, 15B, and 16 show test images of a substrate with dispensed spacer material.

FIGS. 17, 18A, and 18B are example schematics of a substrate with confinement gratings to control the flow of spacer material.

FIG. 19 illustrates an example schematic of a manufacturing apparatus for dispensing spacer material.

FIG. 20 illustrates an example schematic of spacer material dispensed onto a substrate.

FIG. 21 is a flow diagram of an example process for manufacturing waveguide stacks to include spacers.

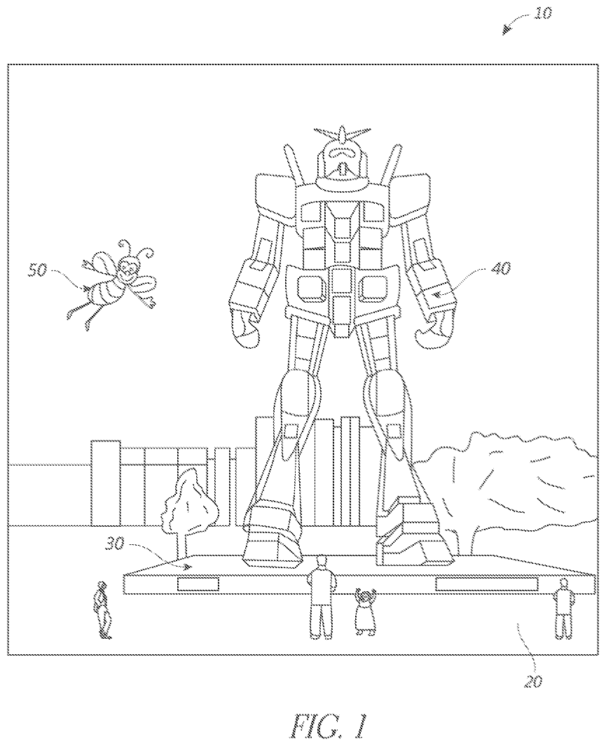

Unless indicated otherwise, like reference numerals in the drawings refer to like parts throughout, and the drawings are not necessarily drawn to scale.

### DETAILED DESCRIPTION

This disclosure describes techniques for manufacturing a waveguide that includes one or more spacers on at least one surface of the waveguide, such that the spacers maintain a desired separation between the waveguides when the waveguides as assembled into a waveguide stack that is usable as an optical device. The disclosure also describes the various implementations of waveguides and optical devices that include spacers. In some implementations, the optical device including the spacer-separated waveguide stack is a component of a wearable (e.g., head mountable) or other type of system that provides an augmented reality (AR), virtual reality (VR), or mixed reality (MR) experience.

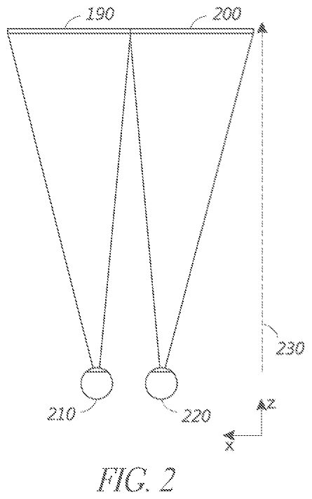

FIG. 2 illustrates a conventional display system for simulating three-dimensional imagery for a user. A user's eyes are spaced apart and that, when looking at a real object in space, each eye will have a slightly different view of the object and may form an image of the object at different locations on the retina of each eye. This may be referred to as binocular disparity and may be utilized by the human visual system to provide a perception of depth. Conventional display systems simulate binocular disparity by presenting two distinct images 190, 200 with slightly different views of the same virtual object—one for each eye 210, 220—corresponding to the views of the virtual object that would be seen by each eye were the virtual object a real object at a desired depth. These images provide binocular cues that the user's visual system may interpret to derive a perception of depth.

With continued reference to FIG. 2, the images 190, 200 are spaced from the eyes 210, 220 by a distance 230 on a z-axis. The z-axis is parallel to the optical axis of the viewer with their eyes fixated on an object at optical infinity directly ahead of the viewer. The images 190, 200 are flat and at a fixed distance from the eyes 210, 220. Based on the slightly different views of a virtual object in the images presented to the eyes 210, 220, respectively, the eyes may naturally rotate such that an image of the object falls on corresponding points on the retinas of each of the eyes, to maintain single binocular vision. This rotation may cause the lines of sight of each of the eyes 210, 220 to converge onto a point in space at which the virtual object is perceived to be present. As a result, providing three-dimensional imagery conventionally involves providing binocular cues that may manipulate the vergence of the user's eyes 210, 220, and that the human visual system interprets to provide a perception of depth.

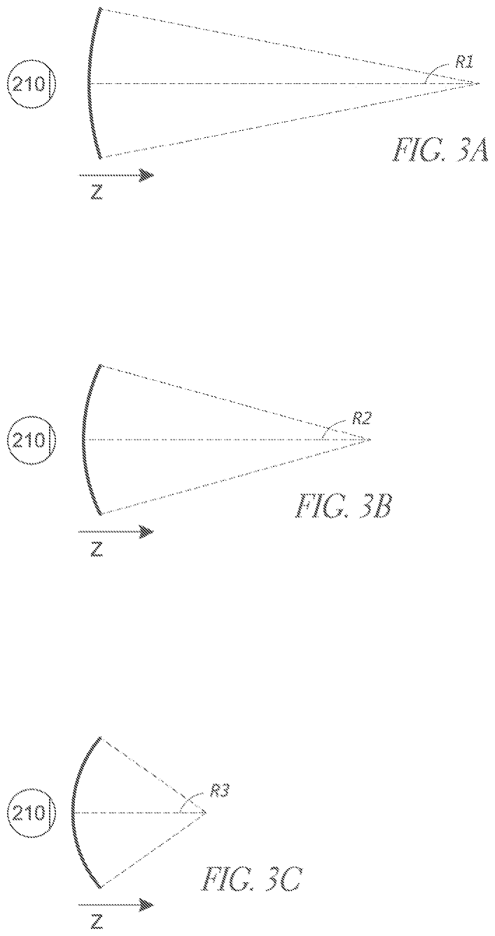

Generating a realistic and comfortable perception of depth is challenging, however. It will be appreciated that light from objects at different distances from the eyes have wavefronts with different amounts of divergence. FIGS. 3A-3C illustrate relationships between distance and the divergence of light rays. The distance between the object and the eye 210 is represented by, in order of decreasing distance, R1, R2, and R3. As shown in FIGS. 3A-3C, the light rays become more divergent as distance to the object decreases. Conversely, as distance increases, the light rays become more collimated. Stated another way, it may be said that the light field produced by a point (the object or a part of the object) has a spherical wavefront curvature, which is a function of how far away the point is from the eye of the user. The curvature increases with decreasing distance between the object and the eye 210. While only a single eye 210 is illustrated for clarity of illustration in FIGS. 3A-3C and other figures herein, the discussions regarding eye 210 may be applied to both eyes 210 and 220 of a viewer.

With continued reference to FIGS. 3A-3C, light from an object that the viewer's eyes are fixated on may have different degrees of wavefront divergence. Due to the different amounts of wavefront divergence, the light may be focused differently by the lens of the eye, which in turn may require the lens to assume different shapes to form a focused image on the retina of the eye. Where a focused image is not formed on the retina, the resulting retinal blur acts as a cue to accommodation that causes a change in the shape of the lens of the eye until a focused image is formed on the retina. For example, the cue to accommodation may trigger the ciliary muscles surrounding the lens of the eye to relax or contract, thereby modulating the force applied to the suspensory ligaments holding the lens, thus causing the shape of the lens of the eye to change until retinal blur of an object of fixation is eliminated or minimized, thereby forming a focused image of the object of fixation on the retina (e.g., fovea) of the eye. The process by which the lens of the eye changes shape may be referred to as accommodation, and the shape of the lens of the eye required to form a focused image of the object of fixation on the retina (e.g., fovea) of the eye may be referred to as an accommodative state.

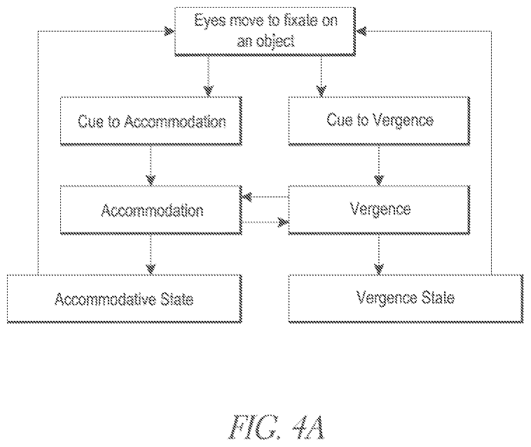

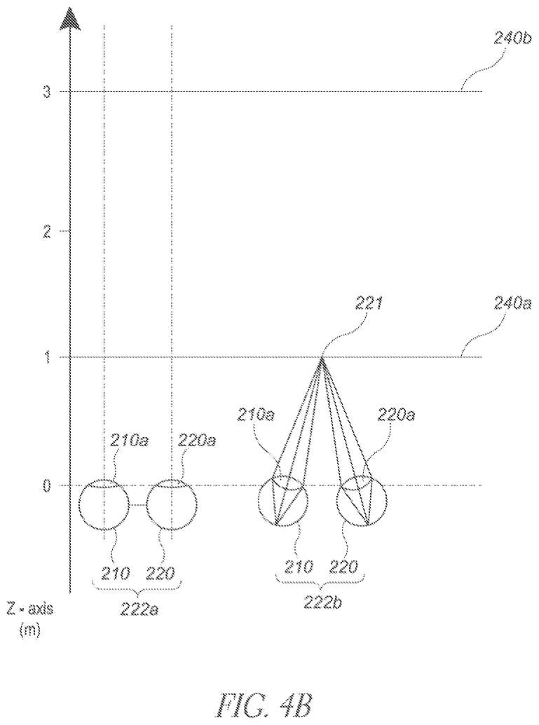

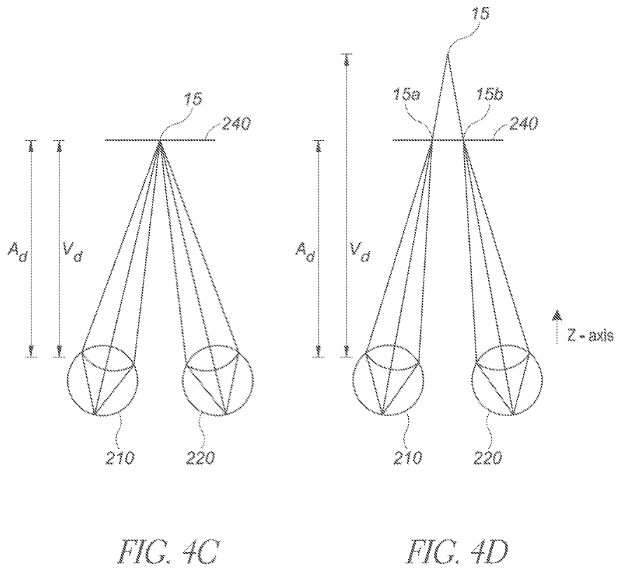

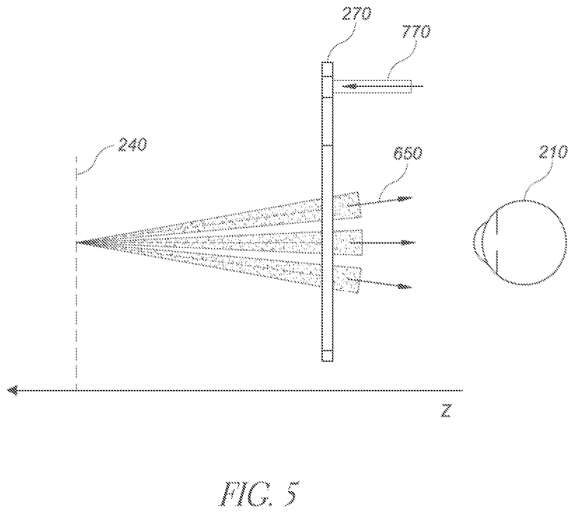

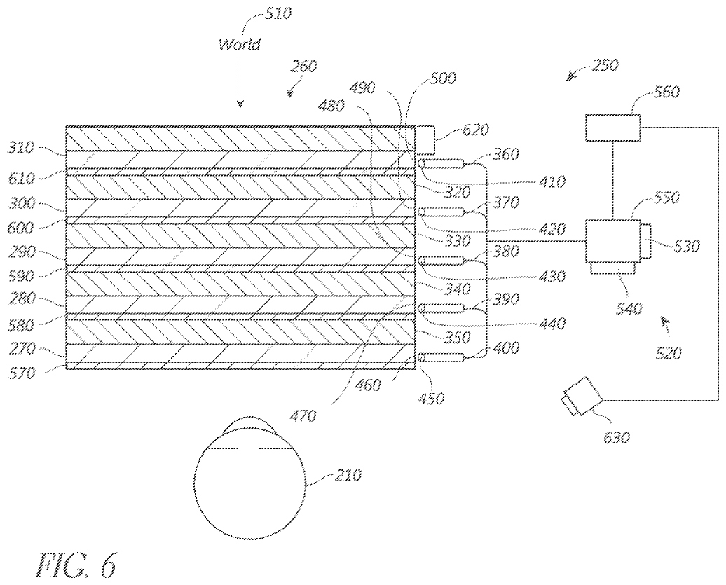

With reference now to FIG. 4A, a representation of the accommodation-vergence response of the human visual system is illustrated. The movement of the eyes to fixate on an object causes the eyes to receive light from the object, with the light forming an image on each of the retinas of the eyes. The presence of retinal blur in the image formed on the retina may provide a cue to accommodation, and the relative locations of the image on the retinas may provide a cue to vergence. The cue to accommodation causes accommodation to occur, resulting in the lenses of the eyes each assuming a particular accommodative state that forms a focused image of the object on the retina (e.g., fovea) of the eye. On the other hand, the cue to vergence causes vergence movements (rotation of the eyes) to occur such that the images formed on each retina of each eye are at corresponding retinal points that maintain single binocular vision. In these positions, the eyes may be said to have assumed a particular vergence state. With continued reference to FIG. 4A, accommodation may be understood to be the process by which the eye achieves a particular accommodative state, and vergence may be understood to be the process by which the eye achieves a particular vergence state. As indicated in FIG. 4A, the accommodative and vergence states of the eyes may change if the user fixates on another object. For example, the accommodated state may change if the user fixates on a new object at a different depth on the z-axis.

Without being limited by theory, it is believed that viewers of an object may perceive the object as being “three-dimensional” due to a combination of vergence and accommodation. As noted above, vergence movements (e.g., rotation of the eyes so that the pupils move toward or away from each other to converge the lines of sight of the eyes to fixate upon an object) of the two eyes relative to each other are closely associated with accommodation of the lenses of the eyes. Under normal conditions, changing the shapes of the lenses of the eyes to change focus from one object to another object at a different distance will automatically cause a matching change in vergence to the same distance, under a relationship known as the “accommodation-vergence reflex.” Likewise, a change in vergence will trigger a matching change in lens shape under normal conditions.

With reference now to FIG. 4B, examples of different accommodative and vergence states of the eyes are illustrated. The pair of eyes 222a is fixated on an object at optical infinity, while the pair eyes 222b are fixated on an object 221 at less than optical infinity. Notably, the vergence states of each pair of eyes is different, with the pair of eyes 222a directed straight ahead, while the pair of eyes 222 converge on the object 221. The accommodative states of the eyes forming each pair of eyes 222a and 222b are also different, as represented by the different shapes of the lenses 210a, 220a.

Undesirably, many users of conventional “3-D” display systems find such conventional systems to be uncomfortable or may not perceive a sense of depth at all due to a mismatch between accommodative and vergence states in these displays. As noted above, many stereoscopic or “3-D” display systems display a scene by providing slightly different images to each eye. Such systems are uncomfortable for many viewers, since they, among other things, simply provide different presentations of a scene and cause changes in the vergence states of the eyes, but without a corresponding change in the accommodative states of those eyes. Rather, the images are shown by a display at a fixed distance from the eyes, such that the eyes view all the image information at a single accommodative state. Such an arrangement works against the “accommodation-vergence reflex” by causing changes in the vergence state without a matching change in the accommodative state. This mismatch is believed to cause viewer discomfort. Display systems that provide a better match between accommodation and vergence may form more realistic and comfortable simulations of three-dimensional imagery.

Without being limited by theory, it is believed that the human eye typically may interpret a finite number of depth planes to provide depth perception. Consequently, a highly believable simulation of perceived depth may be achieved by providing, to the eye, different presentations of an image corresponding to each of these limited numbers of depth planes. In some embodiments, the different presentations may provide both cues to vergence and matching cues to accommodation, thereby providing physiologically correct accommodation-vergence matching.

With continued reference to FIG. 4B, two depth planes 240, corresponding to different distances in space from the eyes 210, 220, are illustrated. For a given depth plane 240, vergence cues may be provided by the displaying of images of appropriately different perspectives for each eye 210, 220. In addition, for a given depth plane 240, light forming the images provided to each eye 210, 220 may have a wavefront divergence corresponding to a light field produced by a point at the distance of that depth plane 240.

In the illustrated embodiment, the distance, along the z-axis, of the depth plane 240 containing the point 221 is 1 m. As used herein, distances or depths along the z-axis may be measured with a zero-point located at the exit pupils of the user's eyes. Thus, a depth plane 240 located at a depth of 1 m corresponds to a distance of 1 m away from the exit pupils of the user's eyes, on the optical axis of those eyes with the eyes directed towards optical infinity. As an approximation, the depth or distance along the z-axis may be measured from the display in front of the user's eyes (e.g., from the surface of a waveguide), plus a value for the distance between the device and the exit pupils of the user's eyes. That value may be called the eye relief and corresponds to the distance between the exit pupil of the user's eye and the display worn by the user in front of the eye. In practice, the value for the eye relief may be a normalized value used generally for all viewers. For example, the eye relief may be assumed to be 20 mm and a depth plane that is at a depth of 1 m may be at a distance of 980 mm in front of the display.

With reference now to FIGS. 4C and 4D, examples of matched accommodation-vergence distances and mismatched accommodation-vergence distances are illustrated, respectively. As illustrated in FIG. 4C, the display system may provide images of a virtual object to each eye 210, 220. The images may cause the eyes 210, 220 to assume a vergence state in which the eyes converge on a point 15 on a depth plane 240. In addition, the images may be formed by a light having a wavefront curvature corresponding to real objects at that depth plane 240. As a result, the eyes 210, 220 assume an accommodative state in which the images are in focus on the retinas of those eyes. Thus, the user may perceive the virtual object as being at the point 15 on the depth plane 240.

It will be appreciated that each of the accommodative and vergence states of the eyes 210, 220 are associated with a particular distance on the z-axis. For example, an object at a particular distance from the eyes 210, 220 causes those eyes to assume particular accommodative states based upon the distances of the object. The distance associated with a particular accommodative state may be referred to as the accommodation distance, Ad. Similarly, there are particular vergence distances, Vd, associated with the eyes in particular vergence states, or positions relative to one another. Where the accommodation distance and the vergence distance match, the relationship between accommodation and vergence may be said to be physiologically correct. This is considered to be the most comfortable scenario for a viewer.

In stereoscopic displays, however, the accommodation distance and the vergence distance may not always match. For example, as illustrated in FIG. 4D, images displayed to the eyes 210, 220 may be displayed with wavefront divergence corresponding to depth plane 240, and the eyes 210, 220 may assume a particular accommodative state in which the points 15a, 15b on that depth plane are in focus. However, the images displayed to the eyes 210, 220 may provide cues for vergence that cause the eyes 210, 220 to converge on a point 15 that is not located on the depth plane 240. As a result, the accommodation distance corresponds to the distance from the exit pupils of the eyes 210, 220 to the depth plane 240, while the vergence distance corresponds to the larger distance from the exit pupils of the eyes 210, 220 to the point 15, in some embodiments. The accommodation distance is different from the vergence distance. Consequently, there is an accommodation-vergence mismatch. Such a mismatch is considered undesirable and may cause discomfort in the user. It will be appreciated that the mismatch corresponds to distance (e.g., Vd-Ad) and may be characterized using diopters.

In some embodiments, it will be appreciated that a reference point other than exit pupils of the eyes 210, 220 may be utilized for determining distance for determining accommodation-vergence mismatch, so long as the same reference point is utilized for the accommodation distance and the vergence distance. For example, the distances could be measured from the cornea to the depth plane, from the retina to the depth plane, from the eyepiece (e.g., a waveguide of the display device) to the depth plane, and so on.

Without being limited by theory, it is believed that users may still perceive accommodation-vergence mismatches of up to about 0.25 diopter, up to about 0.33 diopter, and up to about 0.5 diopter as being physiologically correct, without the mismatch itself causing significant discomfort. In some embodiments, display systems disclosed herein (e.g., the display system 250, FIG. 6) present images to the viewer having accommodation-vergence mismatch of about 0.5 diopter or less. In some other embodiments, the accommodation-vergence mismatch of the images provided by the display system is about 0.33 diopter or less. In yet other embodiments, the accommodation-vergence mismatch of the images provided by the display system is about 0.25 diopter or less, including about 0.1 diopter or less.

FIG. 5 illustrates aspects of an approach for simulating three-dimensional imagery by modifying wavefront divergence. The display system includes a waveguide 270 that is configured to receive light 770 that is encoded with image information, and to output that light to the user's eye 210. The waveguide 270 may output the light 650 with a defined amount of wavefront divergence corresponding to the wavefront divergence of a light field produced by a point on a desired depth plane 240. In some embodiments, the same amount of wavefront divergence is provided for all objects presented on that depth plane. In addition, it will be illustrated that the other eye of the user may be provided with image information from a similar waveguide.

In some embodiments, a single waveguide may be configured to output light with a set amount of wavefront divergence corresponding to a single or limited number of depth planes and/or the waveguide may be configured to output light of a limited range of wavelengths. Consequently, in some embodiments, a plurality or stack of waveguides may be utilized to provide different amounts of wavefront divergence for different depth planes and/or to output light of different ranges of wavelengths. As used herein, it will be appreciated at a depth plane may be planar or may follow the contours of a curved surface.

FIG. 6 illustrates an example of a waveguide stack for outputting image information to a user. A display system 250 includes a stack of waveguides, or stacked waveguide assembly, 260 that may be utilized to provide three-dimensional perception to the eye/brain using a plurality of waveguides 270, 280, 290, 300, 310. It will be appreciated that the display system 250 may be considered a light field display in some embodiments. In addition, the waveguide assembly 260 may also be referred to as an eyepiece.

In some embodiments, the display system 250 is configured to provide substantially continuous cues to vergence and multiple discrete cues to accommodation. The cues to vergence can be provided by displaying different images to each of the eyes of the user, and the cues to accommodation may be provided by outputting the light that forms the images with selectable discrete amounts of wavefront divergence. Stated another way, the display system 250 may be configured to output light with variable levels of wavefront divergence. In some embodiments, each discrete level of wavefront divergence corresponds to a particular depth plane and may be provided by a particular one of the waveguides 270, 280, 290, 300, 310.

With continued reference to FIG. 6, the waveguide assembly 260 may also include a plurality of features 320, 330, 340, 350 between the waveguides. In some embodiments, the features 320, 330, 340, 350 may be one or more lenses. The waveguides 270, 280, 290, 300, 310 and/or the plurality of lenses 320, 330, 340, 350 may be configured to send image information to the eye with various levels of wavefront curvature or light ray divergence. Each waveguide level may be associated with a particular depth plane and can be configured to output image information corresponding to that depth plane. Image injection devices 360, 370, 380, 390, 400 may function as a source of light for the waveguides and may be utilized to inject image information into the waveguides 270, 280, 290, 300, 310, each of which may be configured, as described herein, to distribute incoming light across each respective waveguide, for output toward the eye 210. Light exits an output surface 410, 420, 430, 440, 450 of the image injection devices 360, 370, 380, 390, 400 and is injected into a corresponding input surface 460, 470, 480, 490, 500 of the waveguides 270, 280, 290, 300, 310. In some embodiments, each of the input surfaces 460, 470, 480, 490, 500 may be an edge of a corresponding waveguide, or may be part of a major surface of the corresponding waveguide (that is, one of the waveguide surfaces directly facing the world 510 or the viewer's eye 210). In some embodiments, a single beam of light (e.g. a collimated beam) may be injected into each waveguide to output an entire field of cloned collimated beams that are directed toward the eye 210 at particular angles (and amounts of divergence) corresponding to the depth plane associated with a particular waveguide. In some embodiments, a single one of the image injection devices 360, 370, 380, 390, 400 may be associated with and inject light into a plurality (e.g., three) of the waveguides 270, 280, 290, 300, 310.

In some embodiments, the image injection devices 360, 370, 380, 390, 400 are discrete displays that each produce image information for injection into a corresponding waveguide 270, 280, 290, 300, 310, respectively. In some other embodiments, the image injection devices 360, 370, 380, 390, 400 are the output ends of a single multiplexed display which may, e.g., pipe image information via one or more optical conduits (such as fiber optic cables) to each of the image injection devices 360, 370, 380, 390, 400. It will be appreciated that the image information provided by the image injection devices 360, 370, 380, 390, 400 may include light of different wavelengths, or colors (e.g., different component colors, as discussed herein).

In some embodiments, the light injected into the waveguides 270, 280, 290, 300, 310 is provided by a light projector system 520, which comprises a light module 530, which may include a light emitter, such as a light emitting diode (LED). The light from the light module 530 may be directed to and modified by a light modulator 540, e.g., a spatial light modulator, via a beam splitter 550. The light modulator 540 may be configured to change the perceived intensity of the light injected into the waveguides 270, 280, 290, 300, 310 to encode the light with image information. Examples of spatial light modulators include liquid crystal displays (LCD) including a liquid crystal on silicon (LCOS) displays. It will be appreciated that the image injection devices 360, 370, 380, 390, 400 are illustrated schematically and, in some embodiments, these image injection devices may represent different light paths and locations in a common projection system configured to output light into associated ones of the waveguides 270, 280, 290, 300, 310. In some embodiments, the waveguides of the waveguide assembly 260 may function as ideal lens while relaying light injected into the waveguides out to the user's eyes. In this conception, the object may be the spatial light modulator 540 and the image may be the image on the depth plane.

In some examples, μLED displays can be used in light projector system 520. μLED displays can unpolarized light over a large range of angles. Accordingly, μLED displays can beneficially provide imagery over wide fields of view with high efficiency.

In some embodiments, the display system 250 may be a scanning fiber display with one or more scanning fibers configured to project light in various patterns (e.g., raster scan, spiral scan, Lissajous patterns, etc.) into one or more waveguides 270, 280, 290, 300, 310 and ultimately to the eye 210 of the viewer. In some embodiments, the illustrated image injection devices 360, 370, 380, 390, 400 may schematically represent a single scanning fiber or a bundle of scanning fibers configured to inject light into one or a plurality of the waveguides 270, 280, 290, 300, 310. In some other embodiments, the illustrated image injection devices 360, 370, 380, 390, 400 may schematically represent a plurality of scanning fibers or a plurality of bundles of scanning fibers, each of which are configured to inject light into an associated one of the waveguides 270, 280, 290, 300, 310. It will be appreciated that one or more optical fibers may be configured to transmit light from the light module 530 to the one or more waveguides 270, 280, 290, 300, 310. It will be appreciated that one or more intervening optical structures may be provided between the scanning fiber, or fibers, and the one or more waveguides 270, 280, 290, 300, 310 to, e.g., redirect light exiting the scanning fiber into the one or more waveguides 270, 280, 290, 300, 310.

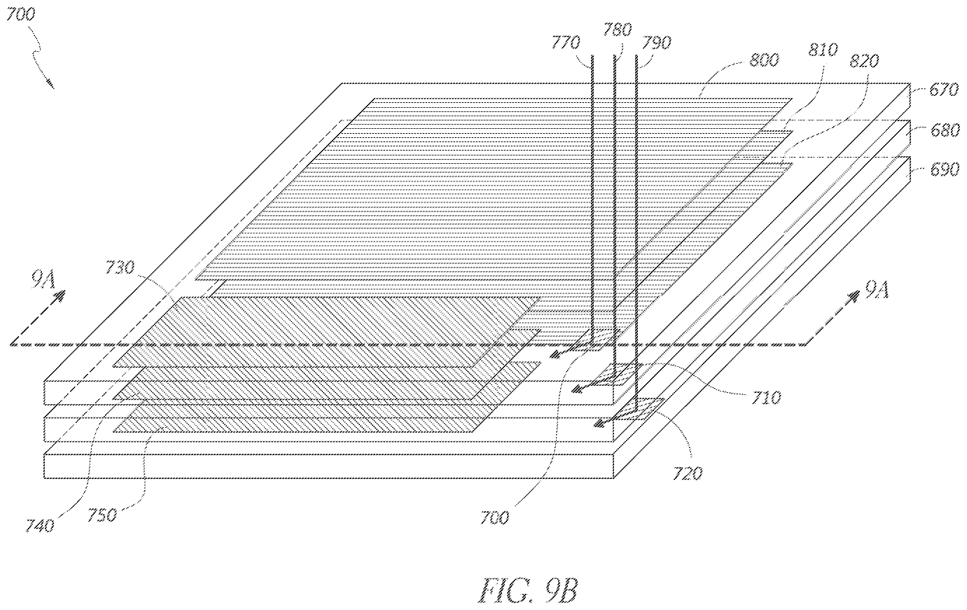

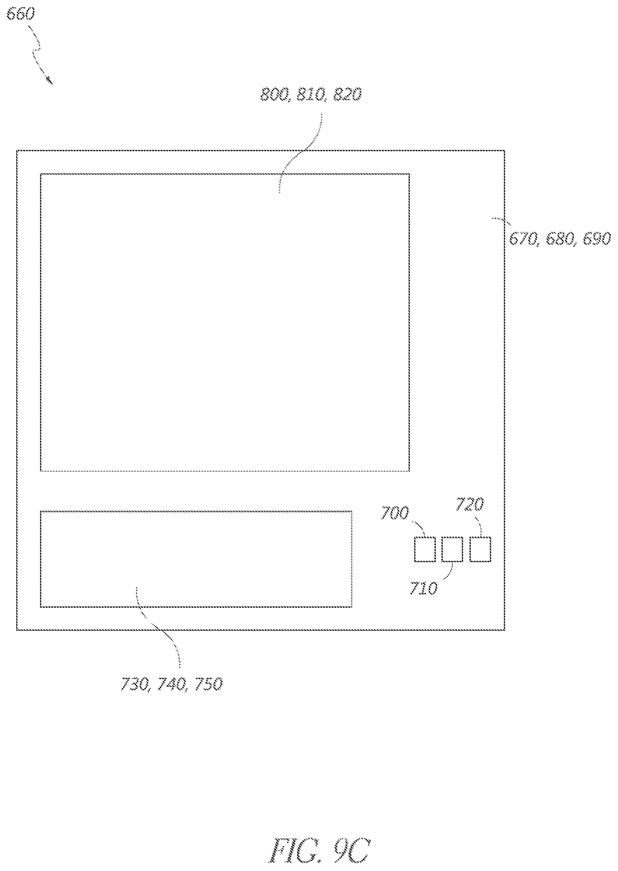

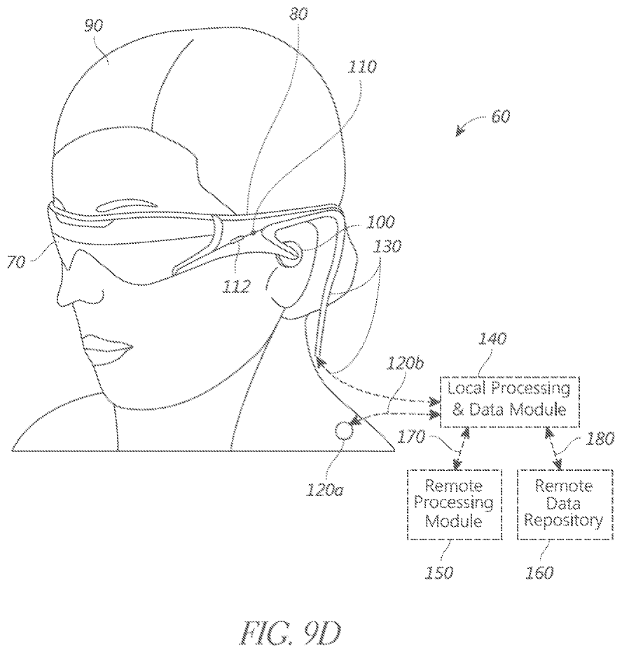

A controller 560 controls the operation of one or more of the stacked waveguide assembly 260, including operation of the image injection devices 360, 370, 380, 390, 400, the light source 530, and the light modulator 540. In some embodiments, the controller 560 is part of the local data processing module 140. The controller 560 includes programming (e.g., instructions in a non-transitory medium) that regulates the timing and provision of image information to the waveguides 270, 280, 290, 300, 310 according to, e.g., any of the various schemes disclosed herein. In some embodiments, the controller may be a single integral device, or a distributed system connected by wired or wireless communication channels. The controller 560 may be part of the processing modules 140 or 150 (FIG. 9D) in some embodiments.

With continued reference to FIG. 6, the waveguides 270, 280, 290, 300, 310 may be configured to propagate light within each respective waveguide by total internal reflection (TIR). The waveguides 270, 280, 290, 300, 310 may each be planar or have another shape (e.g., curved), with major top and bottom surfaces and edges extending between those major top and bottom surfaces. In the illustrated configuration, the waveguides 270, 280, 290, 300, 310 may each include out-coupling optical elements 570, 580, 590, 600, 610 that are configured to extract light out of a waveguide by redirecting the light, propagating within each respective waveguide, out of the waveguide to output image information to the eye 210. Extracted light may also be referred to as out-coupled light and the out-coupling optical elements light may also be referred to light extracting optical elements. An extracted beam of light may be outputted by the waveguide at locations at which the light propagating in the waveguide strikes a light extracting optical element. The out-coupling optical elements 570, 580, 590, 600, 610 may, for example, be gratings, including diffractive optical features, as discussed further herein. While illustrated disposed at the bottom major surfaces of the waveguides 270, 280, 290, 300, 310, for ease of description and drawing clarity, in some embodiments, the out-coupling optical elements 570, 580, 590, 600, 610 may be disposed at the top and/or bottom major surfaces, and/or may be disposed directly in the volume of the waveguides 270, 280, 290, 300, 310, as discussed further herein. In some embodiments, the out-coupling optical elements 570, 580, 590, 600, 610 may be formed in a layer of material that is attached to a transparent substrate to form the waveguides 270, 280, 290, 300, 310. In some other embodiments, the waveguides 270, 280, 290, 300, 310 may be a monolithic piece of material and the out-coupling optical elements 570, 580, 590, 600, 610 may be formed on a surface and/or in the interior of that piece of material.

With continued reference to FIG. 6, as discussed herein, each waveguide 270, 280, 290, 300, 310 is configured to output light to form an image corresponding to a particular depth plane. For example, the waveguide 270 nearest the eye may be configured to deliver collimated light (which was injected into such waveguide 270), to the eye 210. The collimated light may be representative of the optical infinity focal plane. The next waveguide up 280 may be configured to send out collimated light which passes through the first lens 350 (e.g., a negative lens) before it may reach the eye 210; such first lens 350 may be configured to create a slight convex wavefront curvature so that the eye/brain interprets light coming from that next waveguide up 280 as coming from a first focal plane closer inward toward the eye 210 from optical infinity. Similarly, the third up waveguide 290 passes its output light through both the first 350 and second 340 lenses before reaching the eye 210; the combined optical power of the first 350 and second 340 lenses may be configured to create another incremental amount of wavefront curvature so that the eye/brain interprets light coming from the third waveguide 290 as coming from a second focal plane that is even closer inward toward the person from optical infinity than was light from the next waveguide up 280.

The other waveguide layers 300, 310 and lenses 330, 320 are similarly configured, with the highest waveguide 310 in the stack sending its output through all of the lenses between it and the eye for an aggregate focal power representative of the closest focal plane to the person. To compensate for the stack of lenses 320, 330, 340, 350 when viewing/interpreting light coming from the world 510 on the other side of the stacked waveguide assembly 260, a compensating lens layer 620 may be disposed at the top of the stack to compensate for the aggregate power of the lens stack 320, 330, 340, 350 below. Such a configuration provides as many perceived focal planes as there are available waveguide/lens pairings. Both the out-coupling optical elements of the waveguides and the focusing aspects of the lenses may be static (i.e., not dynamic or electro-active). In some alternative embodiments, either or both may be dynamic using electro-active features.

In some embodiments, two or more of the waveguides 270, 280, 290, 300, 310 may have the same associated depth plane. For example, multiple waveguides 270, 280, 290, 300, 310 may be configured to output images set to the same depth plane, or multiple subsets of the waveguides 270, 280, 290, 300, 310 may be configured to output images set to the same plurality of depth planes, with one set for each depth plane. This may provide advantages for forming a tiled image to provide an expanded field of view at those depth planes.

With continued reference to FIG. 6, the out-coupling optical elements 570, 580, 590, 600, 610 may be configured to both redirect light out of their respective waveguides and to output this light with the appropriate amount of divergence or collimation for a particular depth plane associated with the waveguide. As a result, waveguides having different associated depth planes may have different configurations of out-coupling optical elements 570, 580, 590, 600, 610, which output light with a different amount of divergence depending on the associated depth plane. In some embodiments, the light extracting optical elements 570, 580, 590, 600, 610 may be volumetric or surface features, which may be configured to output light at specific angles. For example, the light extracting optical elements 570, 580, 590, 600, 610 may be volume holograms, surface holograms, and/or diffraction gratings. In some embodiments, the features 320, 330, 340, 350 may not be lenses; rather, they may simply be spacers (e.g., cladding layers and/or structures for forming air gaps).

In some embodiments, the out-coupling optical elements 570, 580, 590, 600, 610 are diffractive features that form a diffraction pattern, or “diffractive optical element” (also referred to herein as a “DOE”). Preferably, the DOE's have a sufficiently low diffraction efficiency so that only a portion of the light of the beam is deflected away toward the eye 210 with each intersection of the DOE, while the rest continues to move through a waveguide via TIR. The light carrying the image information is thus divided into a number of related exit beams that exit the waveguide at a multiplicity of locations and the result is a fairly uniform pattern of exit emission toward the eye 210 for this particular collimated beam bouncing around within a waveguide.

In some embodiments, one or more DOEs may be switchable between “on” states in which they actively diffract, and “off” states in which they do not significantly diffract. For instance, a switchable DOE may comprise a layer of polymer dispersed liquid crystal, in which microdroplets comprise a diffraction pattern in a host medium, and the refractive index of the microdroplets may be switched to substantially match the refractive index of the host material (in which case the pattern does not appreciably diffract incident light) or the microdroplet may be switched to an index that does not match that of the host medium (in which case the pattern actively diffracts incident light).

In some embodiments, a camera assembly 630 (e.g., a digital camera, including visible light and infrared light cameras) may be provided to capture images of the eye 210 and/or tissue around the eye 210 to, e.g., detect user inputs and/or to monitor the physiological state of the user. As used herein, a camera may be any image capture device. In some embodiments, the camera assembly 630 may include an image capture device and a light source to project light (e.g., infrared light) to the eye, which may then be reflected by the eye and detected by the image capture device. In some embodiments, the camera assembly 630 may be attached to the frame 80 (FIG. 9D) and may be in electrical communication with the processing modules 140 and/or 150, which may process image information from the camera assembly 630. In some embodiments, one camera assembly 630 may be utilized for each eye, to separately monitor each eye.

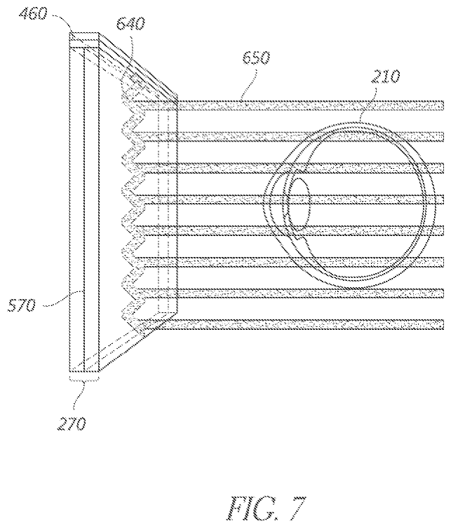

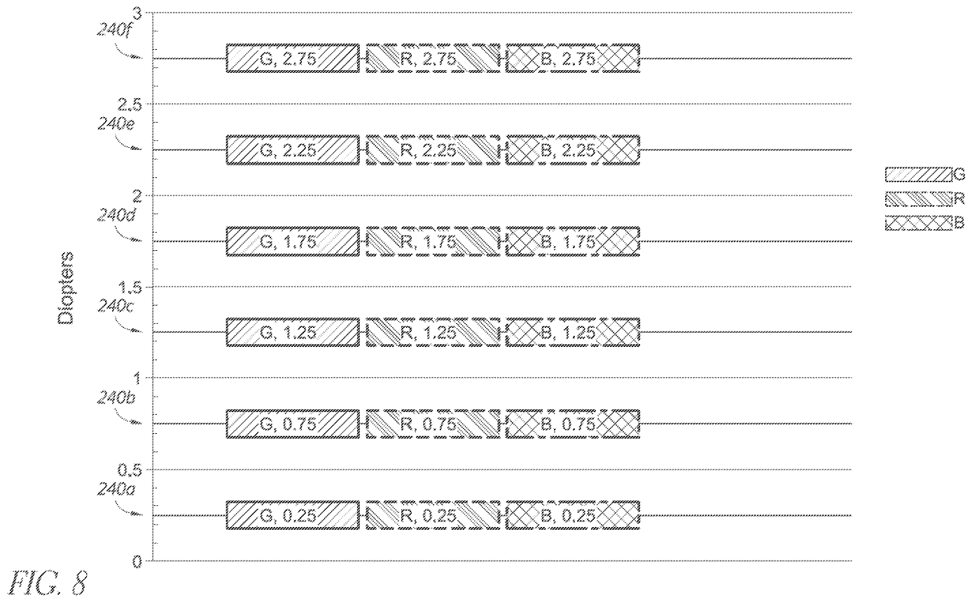

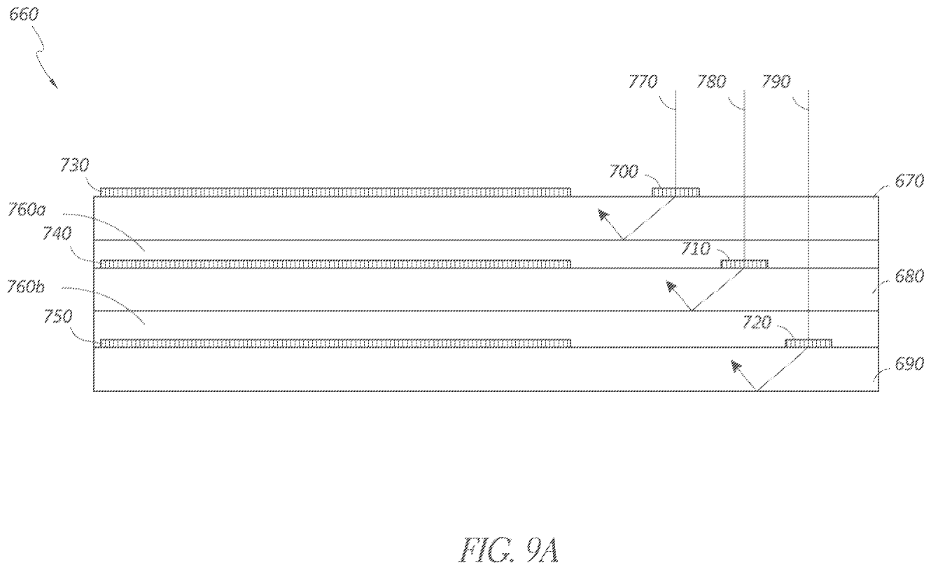

With reference now to FIG. 7, an example of exit beams outputted by a waveguide is shown. One waveguide is illustrated, but it will be appreciated that other waveguides in the waveguide assembly 260 (FIG. 6) may function similarly, where the waveguide assembly 260 includes multiple waveguides. Light 640 is injected into the waveguide 270 at the input surface 460 of the waveguide 270 and propagates within the waveguide 270 by TIR. At points where the light 640 impinges on the DOE 570, a portion of the light exits the waveguide as exit beams 650. The exit beams 650 are illustrated as substantially parallel but, as discussed herein, they may also be redirected to propagate to the eye 210 at an angle (e.g., forming divergent exit beams), depending on the depth plane associated with the waveguide 270. It will be appreciated that substantially parallel exit beams may be indicative of a waveguide with out-coupling optical elements that out-couple light to form images that appear to be set on a depth plane at a large distance (e.g., optical infinity) from the eye 210. Other waveguides or other sets of out-coupling optical elements may output an exit beam pattern that is more divergent, which would require the eye 210 to accommodate to a closer distance to bring it into focus on the retina and would be interpreted by the brain as light from a distance closer to the eye 210 than optical infinity.

In some embodiments, a full color image may be formed at each depth plane by overlaying images in each of the component colors, e.g., three or more component colors. FIG. 8 illustrates an example of a stacked waveguide assembly in which each depth plane includes images formed using multiple different component colors. The illustrated embodiment shows depth planes 240a-240f, although more or fewer depths are also contemplated. Each depth plane may have three or more component color images associated with it, including: a first image of a first color, G; a second image of a second color, R; and a third image of a third color, B. Different depth planes are indicated in the figure by different numbers for diopters (dpt) following the letters G, R, and B. Just as examples, the numbers following each of these letters indicate diopters (1/m), or inverse distance of the depth plane from a viewer, and each box in the figures represents an individual component color image. In some embodiments, to account for differences in the eye's focusing of light of different wavelengths, the exact placement of the depth planes for different component colors may vary. For example, different component color images for a given depth plane may be placed on depth planes corresponding to different distances from the user. Such an arrangement may increase visual acuity and user comfort and/or may decrease chromatic aberrations.

In some embodiments, light of each component color may be outputted by a single dedicated waveguide and, consequently, each depth plane may have multiple waveguides associated with it. In such embodiments, each box in the figures including the letters G, R, or B may be understood to represent an individual waveguide, and three waveguides may be provided per depth plane where three component color images are provided per depth plane. While the waveguides associated with each depth plane are shown adjacent to one another in this drawing for ease of description, it will be appreciated that, in a physical device, the waveguides may all be arranged in a stack with one waveguide per level. In some other embodiments, multiple component colors may be outputted by the same waveguide, such that, e.g., only a single waveguide may be provided per depth plane.

With continued reference to FIG. 8, in some embodiments, G is the color green, R is the color red, and B is the color blue. In some other embodiments, other colors associated with other wavelengths of light, including magenta and cyan, may be used in addition to or may replace one or more of red, green, or blue.

It will be appreciated that references to a given color of light throughout this disclosure will be understood to encompass light of one or more wavelengths within a range of wavelengths of light that are perceived by a viewer as being of that given color. For example, red light may include light of one or more wavelengths in the range of about 620-780 nm, green light may include light of one or more wavelengths in the range of about 492-577 nm, and blue light may include light of one or more wavelengths in the range of about 435-493 nm.

In some embodiments, the light source 530 (FIG. 6) may be configured to emit light of one or more wavelengths outside the visual perception range of the viewer, for example, infrared and/or ultraviolet wavelengths. In addition, the in-coupling, out-coupling, and other light redirecting structures of the waveguides of the display 250 may be configured to direct and emit this light out of the display towards the user's eye 210, e.g., for imaging and/or user stimulation applications.

With reference now to FIG. 9A, in some embodiments, light impinging on a waveguide may need to be redirected to in-couple that light into the waveguide. An in-coupling optical element may be used to redirect and in-couple the light into its corresponding waveguide. FIG. 9A illustrates a cross-sectional side view of an example of a plurality or set 660 of stacked waveguides that each includes an in-coupling optical element. The waveguides may each be configured to output light of one or more different wavelengths, or one or more different ranges of wavelengths. It will be appreciated that the stack 660 may correspond to the stack 260 (FIG. 6) and the illustrated waveguides of the stack 660 may correspond to part of the plurality of waveguides 270, 280, 290, 300, 310, except that light from one or more of the image injection devices 360, 370, 380, 390, 400 is injected into the waveguides from a position that requires light to be redirected for in-coupling.

The illustrated set 660 of stacked waveguides includes waveguides 670, 680, and 690. Each waveguide includes an associated in-coupling optical element (which may also be referred to as a light input area on the waveguide), with, e.g., in-coupling optical element 700 disposed on a major surface (e.g., an upper major surface) of waveguide 670, in-coupling optical element 710 disposed on a major surface (e.g., an upper major surface) of waveguide 680, and in-coupling optical element 720 disposed on a major surface (e.g., an upper major surface) of waveguide 690. In some embodiments, one or more of the in-coupling optical elements 700, 710, 720 may be disposed on the bottom major surface of the respective waveguide 670, 680, 690 (particularly where the one or more in-coupling optical elements are reflective, deflecting optical elements). As illustrated, the in-coupling optical elements 700, 710, 720 may be disposed on the upper major surface of their respective waveguide 670, 680, 690 (or the top of the next lower waveguide), particularly where those in-coupling optical elements are transmissive, deflecting optical elements. In some embodiments, the in-coupling optical elements 700, 710, 720 may be disposed in the body of the respective waveguide 670, 680, 690. In some embodiments, as discussed herein, the in-coupling optical elements 700, 710, 720 are wavelength selective, such that they selectively redirect one or more wavelengths of light, while transmitting other wavelengths of light. While illustrated on one side or corner of their respective waveguide 670, 680, 690, it will be appreciated that the in-coupling optical elements 700, 710, 720 may be disposed in other areas of their respective waveguide 670, 680, 690 in some embodiments.

As illustrated, the in-coupling optical elements 700, 710, 720 may be laterally offset from one another. In some embodiments, each in-coupling optical element may be offset such that it receives light without that light passing through another in-coupling optical element. For example, each in-coupling optical element 700, 710, 720 may be configured to receive light from a different image injection device 360, 370, 380, 390, and 400 as shown in FIG. 6, and may be separated (e.g., laterally spaced apart) from other in-coupling optical elements 700, 710, 720 such that it substantially does not receive light from the other ones of the in-coupling optical elements 700, 710, 720.

Each waveguide also includes associated light distributing elements, with, e.g., light distributing elements 730 disposed on a major surface (e.g., a top major surface) of waveguide 670, light distributing elements 740 disposed on a major surface (e.g., a top major surface) of waveguide 680, and light distributing elements 750 disposed on a major surface (e.g., a top major surface) of waveguide 690. In some other embodiments, the light distributing elements 730, 740, 750, may be disposed on a bottom major surface of associated waveguides 670, 680, 690, respectively. In some other embodiments, the light distributing elements 730, 740, 750, may be disposed on both top and bottom major surface of associated waveguides 670, 680, 690, respectively; or the light distributing elements 730, 740, 750, may be disposed on different ones of the top and bottom major surfaces in different associated waveguides 670, 680, 690, respectively.

The waveguides 670, 680, 690 may be spaced apart and separated by, e.g., gas, liquid, and/or solid layers of material. For example, as illustrated, layer 760a may separate waveguides 670 and 680; and layer 760b may separate waveguides 680 and 690. In some embodiments, the layers 760a and 760b are formed of low refractive index materials (that is, materials having a lower refractive index than the material forming the immediately adjacent one of waveguides 670, 680, 690). Preferably, the refractive index of the material forming the layers 760a, 760b is 0.05 or more, or 0.10 or less than the refractive index of the material forming the waveguides 670, 680, 690. Advantageously, the lower refractive index layers 760a, 760b may function as cladding layers that facilitate TIR of light through the waveguides 670, 680, 690 (e.g., TTR between the top and bottom major surfaces of each waveguide). In some embodiments, the layers 760a, 760b are formed of air. While not illustrated, it will be appreciated that the top and bottom of the illustrated set 660 of waveguides may include immediately neighboring cladding layers.

Preferably, for ease of manufacturing and other considerations, the material forming the waveguides 670, 680, 690 are similar or the same, and the material forming the layers 760a, 760b are similar or the same. In some embodiments, the material forming the waveguides 670, 680, 690 may be different between one or more waveguides, and/or the material forming the layers 760a, 760b may be different, while still holding to the various refractive index relationships noted above.

With continued reference to FIG. 9A, light rays 770, 780, 790 are incident on the set 660 of waveguides. It will be appreciated that the light rays 770, 780, 790 may be injected into the waveguides 670, 680, 690 by one or more image injection devices 360, 370, 380, 390, 400 (FIG. 6).

In some embodiments, the light rays 770, 780, 790 have different properties, e.g., different wavelengths or different ranges of wavelengths, which may correspond to different colors. The in-coupling optical elements 700, 710, 720 each deflect the incident light such that the light propagates through a respective one of the waveguides 670, 680, 690 by TIR. In some embodiments, the incoupling optical elements 700, 710, 720 each selectively deflect one or more particular wavelengths of light, while transmitting other wavelengths to an underlying waveguide and associated incoupling optical element.

For example, in-coupling optical element 700 may be configured to deflect ray 770, which has a first wavelength or range of wavelengths, while transmitting rays 780 and 790, which have different second and third wavelengths or ranges of wavelengths, respectively. The transmitted ray 780 impinges on and is deflected by the in-coupling optical element 710, which is configured to deflect light of a second wavelength or range of wavelengths. The ray 790 is deflected by the in-coupling optical element 720, which is configured to selectively deflect light of third wavelength or range of wavelengths.

With continued reference to FIG. 9A, the deflected light rays 770, 780, 790 are deflected so that they propagate through a corresponding waveguide 670, 680, 690; that is, the in-coupling optical elements 700, 710, 720 of each waveguide deflects light into that corresponding waveguide 670, 680, 690 to in-couple light into that corresponding waveguide. The light rays 770, 780, 790 are deflected at angles that cause the light to propagate through the respective waveguide 670, 680, 690 by TIR. The light rays 770, 780, 790 propagate through the respective waveguide 670, 680, 690 by TIR until impinging on the waveguide's corresponding light distributing elements 730, 740, 750.

With reference now to FIG. 9B, a perspective view of an example of the plurality of stacked waveguides of FIG. 9A is illustrated. As noted above, the in-coupled light rays 770, 780, 790, are deflected by the in-coupling optical elements 700, 710, 720, respectively, and then propagate by TIR within the waveguides 670, 680, 690, respectively. The light rays 770, 780, 790 then impinge on the light distributing elements 730, 740, 750, respectively. The light distributing elements 730, 740, 750 deflect the light rays 770, 780, 790 so that they propagate towards the out-coupling optical elements 800, 810, 820, respectively.

In some embodiments, the light distributing elements 730, 740, 750 are orthogonal pupil expanders (OPE's). In some embodiments, the OPE's deflect or distribute light to the out-coupling optical elements 800, 810, 820 and, in some embodiments, may also increase the beam or spot size of this light as it propagates to the out-coupling optical elements. In some embodiments, the light distributing elements 730, 740, 750 may be omitted and the in-coupling optical elements 700, 710, 720 may be configured to deflect light directly to the out-coupling optical elements 800, 810, 820. For example, with reference to FIG. 9A, the light distributing elements 730, 740, 750 may be replaced with out-coupling optical elements 800, 810, 820, respectively. In some embodiments, the out-coupling optical elements 800, 810, 820 are exit pupils (EP's) or exit pupil expanders (EPE's) that direct light in a viewer's eye 210 (FIG. 7). It will be appreciated that the OPE's may be configured to increase the dimensions of the eye box in at least one axis and the EPE's may be to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EP again, at which time another portion of the impinging light is directed out of the waveguide, and so on. Consequently, a single beam of incoupled light may be “replicated” each time a portion of that light is redirected by an OPE or EPE, thereby forming a field of cloned beams of light, as shown in FIG. 6. In some embodiments, the OPE and/or EPE may be configured to modify a size of the beams of light.

Accordingly, with reference to FIGS. 9A and 9B, in some embodiments, the set 660 of waveguides includes waveguides 670, 680, 690; in-coupling optical elements 700, 710, 720; light distributing elements (e.g., OPE's) 730, 740, 750; and out-coupling optical elements (e.g., EP's) 800, 810, 820 for each component color. The waveguides 670, 680, 690 may be stacked with an air gap/cladding layer between each one. The in-coupling optical elements 700, 710, 720 redirect or deflect incident light (with different in-coupling optical elements receiving light of different wavelengths) into its waveguide. The light then propagates at an angle which will result in TIR within the respective waveguide 670, 680, 690. In the example shown, light ray 770 (e.g., blue light) is deflected by the first in-coupling optical element 700, and then continues to bounce down the waveguide, interacting with the light distributing element (e.g., OPE's) 730 and then the out-coupling optical element (e.g., EPs) 800, in a manner described earlier. The light rays 780 and 790 (e.g., green and red light, respectively) will pass through the waveguide 670, with light ray 780 impinging on and being deflected by in-coupling optical element 710. The light ray 780 then bounces down the waveguide 680 via TIR, proceeding on to its light distributing element (e.g., OPEs) 740 and then the out-coupling optical element (e.g., EP's) 810. Finally, light ray 790 (e.g., red light) passes through the waveguide 690 to impinge on the light in-coupling optical elements 720 of the waveguide 690. The light in-coupling optical elements 720 deflect the light ray 790 such that the light ray propagates to light distributing element (e.g., OPEs) 750 by TIR, and then to the out-coupling optical element (e.g., EPs) 820 by TIR. The out-coupling optical element 820 then finally out-couples the light ray 790 to the viewer, who also receives the out-coupled light from the other waveguides 670, 680.

FIG. 9C illustrates a top-down plan view of an example of the plurality of stacked waveguides of FIGS. 9A and 9B. As illustrated, the waveguides 670, 680, 690, along with each waveguide's associated light distributing element 730, 740, 750 and associated out-coupling optical element 800, 810, 820, may be vertically aligned. However, as discussed herein, the in-coupling optical elements 700, 710, 720 are not vertically aligned; rather, the in-coupling optical elements are non-overlapping (e.g., laterally spaced apart as seen in the top-down view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially-separated in-coupling optical elements may be referred to as a shifted pupil system, and the in-coupling optical elements within these arrangements may correspond to sub pupils.

Alternatively, in certain embodiments, two or more of the in-coupling optical elements can be in an inline arrangement, in which they are vertically aligned. In such arrangements, light for waveguides further from the projection system is transmitted through the in-coupling optical elements for waveguides closer to the projection system, preferably with minimal scattering or diffraction.

Inline configurations can advantageously reduce the size of and simplify the projector. Moreover, it can increase the field of view of the eyepiece, e.g., by coupling of same color to several waveguides by making use of crosstalk. For example, green light can be coupled into blue and red active layers. Because of the pitch of each ICG can be different to provide improved (e.g., optimal) performance for a specific color, the allowed field of view can be increased.

In inline configurations, except for the last layer in the optical path, the ICGs should be either at most partially reflective or otherwise transmissive to light having operative wavelengths of subsequent layers in the waveguide stack. In either case, the efficiency can be undesirably low unless the gratings are etched in a high index layer (e.g., 1.8 or more for polymer based layers), or a high index coating is deposited or growth on the grating. However, this approach can increase the back reflection into the projector lens, which thus can generate image artifacts such as image ghosting.

FIG. 9D illustrates an example of wearable display system 60 into which the various waveguides and related systems disclosed herein may be integrated. In some embodiments, the display system 60 is the system 250 of FIG. 6, with FIG. 6 schematically showing some parts of that system 60 in greater detail. For example, the waveguide assembly 260 of FIG. 6 may be part of the display 70.

With continued reference to FIG. 9D, the display system 60 includes a display 70, and various mechanical and electronic modules and systems to support the functioning of that display 70. The display 70 may be coupled to a frame 80, which is wearable by a display system user or viewer 90 and which is configured to position the display 70 in front of the eyes of the user 90. The display 70 may be considered eyewear in some embodiments. In some embodiments, a speaker 100 is coupled to the frame 80 and configured to be positioned adjacent the ear canal of the user 90 (in some embodiments, another speaker, not shown, may optionally be positioned adjacent the other ear canal of the user to provide stereo/shapeable sound control). The display system 60 may also include one or more microphones 110 or other devices to detect sound. In some embodiments, the microphone is configured to allow the user to provide inputs or commands to the system 60 (e.g., the selection of voice menu commands, natural language questions, etc.), and/or may allow audio communication with other persons (e.g., with other users of similar display systems. The microphone may further be configured as a peripheral sensor to collect audio data (e.g., sounds from the user and/or environment). In some embodiments, the display system may also include a peripheral sensor 120a, which may be separate from the frame 80 and attached to the body of the user 90 (e.g., on the head, torso, an extremity, etc. of the user 90). The peripheral sensor 120a may be configured to acquire data characterizing a physiological state of the user 90 in some embodiments. For example, the sensor 120a may be an electrode.

With continued reference to FIG. 9D, the display 70 is operatively coupled by communications link 130, such as by a wired lead or wireless connectivity, to a local data processing module 140 which may be mounted in a variety of configurations, such as fixedly attached to the frame 80, fixedly attached to a helmet or hat worn by the user, embedded in headphones, or otherwise removably attached to the user 90 (e.g., in a backpack-style configuration, in a belt-coupling style configuration). Similarly, the sensor 120a may be operatively coupled by communications link 120b, e.g., a wired lead or wireless connectivity, to the local processor and data module 140. The local processing and data module 140 may comprise a hardware processor, as well as digital memory, such as non-volatile memory (e.g., flash memory or hard disk drives), both of which may be utilized to assist in the processing, caching, and storage of data. Optionally, the local processor and data module 140 may include one or more central processing units (CPUs), graphics processing units (GPUs), dedicated processing hardware, and so on. The data may include data a) captured from sensors (which may be, e.g., operatively coupled to the frame 80 or otherwise attached to the user 90), such as image capture devices (such as cameras), microphones, inertial measurement units, accelerometers, compasses, GPS units, radio devices, gyros, and/or other sensors disclosed herein; and/or b) acquired and/or processed using remote processing module 150 and/or remote data repository 160 (including data relating to virtual content), possibly for passage to the display 70 after such processing or retrieval. The local processing and data module 140 may be operatively coupled by communication links 170, 180, such as via a wired or wireless communication links, to the remote processing module 150 and remote data repository 160 such that these remote modules 150, 160 are operatively coupled to each other and available as resources to the local processing and data module 140. In some embodiments, the local processing and data module 140 may include one or more of the image capture devices, microphones, inertial measurement units, accelerometers, compasses, GPS units, radio devices, and/or gyros. In some other embodiments, one or more of these sensors may be attached to the frame 80, or may be standalone structures that communicate with the local processing and data module 140 by wired or wireless communication pathways.

With continued reference to FIG. 9D, in some embodiments, the remote processing module 150 may comprise one or more processors configured to analyze and process data and/or image information, for instance including one or more central processing units (CPUs), graphics processing units (GPUs), dedicated processing hardware, and so on. In some embodiments, the remote data repository 160 may comprise a digital data storage facility, which may be available through the internet or other networking configuration in a “cloud” resource configuration. In some embodiments, the remote data repository 160 may include one or more remote servers, which provide information, e.g., information for generating augmented reality content, to the local processing and data module 140 and/or the remote processing module 150. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, modules 140, 150, 160, for instance via wireless or wired connections.

Traditionally, the waveguide stacks described above may experience performance degradation over time, if the gap between waveguides does not remain consistent and uniform over the area of the waveguide. For example, in the course of its use over time, the optical device may be exposed to changes in temperature and pressure, and/or physical trauma, that may cause the gap separation between waveguides to change, and/or may cause the waveguides to bend or otherwise deform in an undesirable way to depart from their original design. In extreme case, the gap may be decreased to the extent where the waveguides touch, and light conveyed by one waveguide may couple into another waveguide. In all these scenarios, the performance of the optical device may be dramatically degraded.

Controlling gap thicknesses to maintain a constant gap in a waveguide stack of flat or curved eyepiece waveguide substrates, or to intentionally vary the gap spacing to curve a flat eyepiece waveguide substrate, allows the waveguide stack to operate as an optical device with higher performance characteristics than previously available devices. For example, maintaining the desired gap separation can provide for optical devices that exhibit a larger field of view or better control of the focal depth of the virtual image created by the light conveyed by the waveguides. Currently available approaches of using imprinted pillars or post-imprint dispense of glass or polymer microspheres do not overcome these problems, given that these solutions create spacers that occupy an area of the waveguide surface where otherwise there could be an active area such as a CPE, EPE, or OPE relief structure. Additionally, these traditional solutions provide for spacer structures that are placed at locations that cannot be controlled to a high precision, thus leading to inconsistencies in device performance.

The implementations described herein allow for high-precision and accurate control of the gaps between waveguides (flat or curved) in a waveguide stack. The waveguides may be formed of a polymer material or may be formed of glass, or other suitable materials. Polymer-based materials have a coefficient of thermal expansion (CTE) that is 10 to 100 times higher than materials such as glass, making polymer-based waveguide substrates more vulnerable to deformation over time. Polymers also exhibit approximately 10 to 20 times lower elastic moduli than glass, which further exacerbates the level of deformation and buckling that can occur during thermal expansion. Accordingly, gap inconsistency due to deformation over time may be a particular problem for waveguides that use a polymer substrate, but the problem may also occur with glass substrates. The spacer techniques described herein are useful to maintain consistent gap separation in waveguide stacks in which the waveguide substrate is polymer, glass, or any other suitable material. The spacers described herein also act as a binder between the consecutive layers to reduce in-plane slip and out of place deformations of the (e.g., polymer or glass) waveguides, thus providing additional mechanical stability to the waveguide stack. This intra-layer gap control, along with the minimization of in-plane and out-of-plane deformations, is important to minimize deterioration of various image quality metrics in the optical device.

In some implementations, spacers are created through an inkjetting process in which spacer fluid is dispensed onto the surface of the substrate, and cured to form the finished spacers. The application can involve the use of a single drop dispenser to deposit drops of approximately 1 to 5 nanoliters (nL) of ultraviolet (UV) curable fluids at defined locations on a substrate with high accuracy in drop placement. The fluid of the drops may be of a sufficiently high viscosity to minimize drop spreading and maintain drop radii at 250 μm to 350 μm, with tunable drop heights varying between tens to hundreds of μm. The method involved can use a single drop dispenser such as the Nordson™ PicoPulse™. Other vendors such as Vermes™ also make products which can yield similar results.

To maintain the desired gap spacing between waveguides in the waveguide stack, small drops (e.g., hundreds of μm in diameter) of spacer fluid material can be dispensed onto one or both surfaces of a substrate, to create (approximately) spherical spacers with accurately controlled heights. Thus placed, once the waveguides are assembled into a stack, the spacer act to maintain gap separation and parallelism between waveguides, prevent adjacent waveguides from touching, provide a cushion to absorb shock and otherwise provide mechanical stability to the stack, and in some implementations bond the adjacent layers to one other for additional strength and stability in the structure.

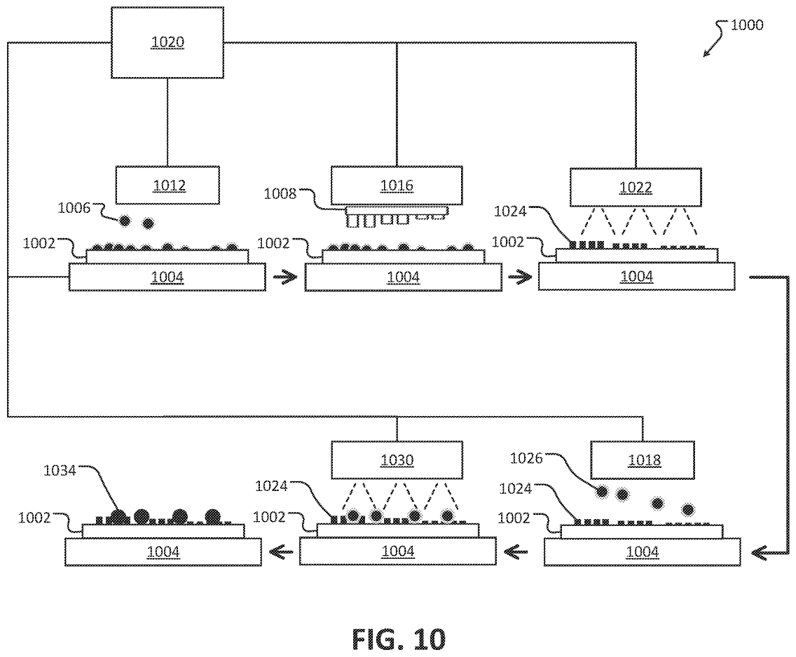

FIG. 10 depicts an example system 1000 for manufacturing waveguides or other types of optical devices. As shown in this example, the system 1000 can include various components that perform various operations to manufacture an optical device, such as a waveguide or an eyepiece, over the course of multiple manufacturing phases. In some implementations, various ones of the example manufacturing phases can be combined or divided into sub-phases. The various operations described may be performed in any suitable order, not limited to the example described.

As shown in FIG. 10, the system 1000 can operate on a substrate 1002 while the substrate is supported by a stage 1004. The stage 1004 can also be described as a chuck. The substrate 1002 may be composed of any suitable material such as glass or polymer. The substrate material may be transparent, and act as a waveguide to convey light through TIR. The substrate 1002 may be in any suitable form, include a sheet, a wafer, a film, and so forth. In some examples, the portion of substrate 1002 (e.g., a wafer) may include multiple regions that each correspond to an eyepiece to be cut out of the substrate 1002 following other manufacturing steps to create the desired patterns (e.g., diffraction gratings) on one or more surfaces of the substrate 1002 and/or create spacers on a surface of the substrate 1002.

The stage 1004 may be configured to support the substrate 1002 and stabilize the substrate 1002 during fluid dispensing, imprinting, curing, etching, singulating, and/or other manufacturing operations. The stage 1004 may be configured to secure the substrate 1002 to the stage 1004, such as through use of a vacuum pump to create suction that holds the substrate 1002 to the stage 1004. The stage 1004 may be moveable to move between different stations of the manufacturing system 1000, as in the example shown where the stage is moved from a fluid dispensing station to an imprinting station to an etching station, and so forth. The stage 1004 may also be configured to move in various directions while in place in proximity (e.g., under) one of the stations. For example, if the stage 1004 is holding the substrate 1002 that has surfaces that are substantially planar and include X- and Y-axes, as shown, the stage 1004 may be configured to move in the X-direction and/or the Y-direction under the station. In some implementations, the stage 1004 may also be configured to be moveable in a Z-direction to increase or decrease the distance between the substrate 1002 and the particular device performing on operation on the substrate 1002 (e.g., the fluid dispenser 1012, the imprint mechanism 1016, the curing mechanism 1022, etc.). In some implementations, the stage 1004 is configured to support the substrate 1002 by its edge such that both broad surfaces of the substrate 1002 are accessible for such operations. In some implementations, the stage 1004 can be configured to flip the substrate 1002 in the Z-direction to make both of the opposite sides of the substrate 1002 available for fluid dispense, imprinting, curing, etching, and/or other operations.

A fluid dispenser 1012 is configured to dispense drops (or droplets) of the fluid 1006, such as resist, onto the substrate 1002. The fluid 1006 may also be referred to as a resist, a photoresist, a resin, or prepolymer. In this disclosure, “prepolymer” and “prepolymer material” are used interchangeably. The fluid can include a resin, such as an epoxy vinyl ester. The color-absorbing resin can include UV and thermally curable crosslinking monomers and oligomers, with or without oxygen inhibitors. To make the color-absorbing resin, dye or pigment is typically premixed with solvent and resin, and a photoinitiator is added to yield the UV curable resin. The dye or pigment can be selected to absorb all or a portion of light in the visible region. In some examples, the dye or pigment is black (i.e., absorbs all visible wavelengths). In other examples, the dye or pigment is blue (i.e., absorbs green and red wavelengths), green (i.e., absorbs blue and red wavelengths), red (i.e., absorbs blue and green wavelengths), or any combination thereof. In particular, a color-absorbing region can include a combination of red, green, and blue dye or pigmented polymer that is not black, but all absorbs wavelength ranges of visible light that is incident on the waveguide. In this disclosure, “polymer” and “polymer material” are used interchangeably.

The resin can include a vinyl monomer (e.g., methyl methacrylate) and/or difunctional or trifunctional vinyl monomers (e.g., diacrylates, triacrylates, dimethacrylates, etc.), with or without aromatic molecules in the monomer. The prepolymer material can include monomer having one or more functional groups such as alkyl, carboxyl, carbonyl, hydroxyl, and/or alkoxyl. Sulfur atoms and aromatic groups, which both have higher polarizability, can be incorporated into these acrylate components to boost the refractive index of the formulation and generally have an index ranging from 1.5-1.75. In some implementations, the prepolymer material can include a cyclic aliphatic epoxy. The prepolymer material can be cured using ultraviolet light and/or heat. In some cases, the prepolymer material can include an ultraviolet cationic photoinitiator and a co-reactant to facilitate efficient ultraviolet curing in ambient conditions.

UV acrylate coatings and films can undergo oxygen inhibition during ambient curing. During curing, oxygen can react with acrylate radicals at the surface to generate peroxide radicals, which are inactive. This can inhibit the chain reaction and result in a sticky, wet surface after UV exposure. A viscosity of the fluid can be in a range of about 10 cPs to about 100,000 cPs or to about 500,000 cPs. Suitable dyes and pigments include carbon black (size range 5 nm-500 nm), Rhodamine B, Tartarzine, chemical dyes from Yamada Chemical Co., Ltd., SUNFAST pigments from SunChemical (e.g., Green 36, Blue, and Violet 23).

The dye or pigment is typically combined with a solvent and then combined with a UV curable resin to yield a color-absorbing resin. The solvent can be a volatile solvent, such as an alcohol (e.g., methanol, ethanol, or butanol) or other less volatile organic solvent (e.g., dimethylsulfoxide (DMSO), propylene glycol monomethyl ether acetate (PGMEA), or toluene). The dye or pigment can be separated from the solvent or concentrated (e.g., using centrifuge evaporation) to yield an optimal concentration with the crosslinking organic resin (e.g., a UV curable highly transparent material). An optimal concentration of the dye or pigment can impart a color-absorbing film with desirable optical characteristics, such as a greater concentration of color-absorbing dye or pigment, and yield less reflective films.

Compared to conventional water and solvent borne coatings, UV radiation curable coatings and adhesives hold additional challenges for balancing acceptable viscosity for the specific application, targeted gloss level, and desired film properties (e.g., scratch resistance, hardness, and adhesion strength). Due to solvent evaporation, conventional coatings start to orient and “concentrate” the matting agent during physical drying of the film. As volatile compounds evaporate, the applied film starts to shrink. This shrinkage can vary between 30% up to 60% of the volume of the wet film, based at least in part on volume solids. Compared to this, 100% UV coatings only shrink about 10% during the rapid cure cycle, which can result in a less dense packing of the matting agent. Matting performance can be improved by careful selection of matting agent particle size and loading selection and film thickness control. Silica based matting agents are typically effective in reducing the glossiness by introducing surface roughness and wrinkling. Examples of silica matting agents include the following from Evonik: Acematt HK 400 (D50 particle size of 6.3 μm), Acematt OK 607 (D50 particle size of 4.4 μm), Acematt OK 412 (D50 particle size of 6.3 μm), and Acematt 3600 (D50 particle size of 5.0 μm).

In addition to the surface roughening approach via inorganic particles, organic components can be added to a prepolymer material to boost internal light scattering to further increase the matting performance. One such component is EBECRYL® 898 radiation curable resin from Allnex. To increase opaqueness of a coating or adhesive against visible light, a broadband absorber such as carbon black pigment can be combined with a matting agent to promote bulk darkness and a flat surface finish. The loading percentage of the pigment can range from about 0.2 wt % to about 15 wt %, based at least in part on the desired curing thickness. In one example, 10 wt % pigment is added to achieve ultra-darkness at a thickness in a range of about 10 microns to about 20 microns. To minimize oxygen inhibition and enhance surface cure in the air, one or more oxygen scavengers and chain transfer agents (e.g., primary, secondary, or tertiary thiols and amines) can be added.

The fluid dispenser 1012 can include one or more printheads (or nozzles) that dispense (e.g., jet) the drops of the fluid 1006. The fluid 1006 can be held in a reservoir, which is connected to the fluid dispenser 1012 by one or more channels (e.g., tubes, conduits, etc.) of suitable type, material, and dimension. One or more fluid pumps can operate to circulate the fluid 1006 between the reservoir and the fluid dispenser 1012. The system 1000 can also include various other suitable devices, such as pumps, pressure sensors, flow sensors, filters, and so forth, arranged to provide a reliable flow of the fluid 1006 to the fluid dispenser 1012.

The fluid dispenser 1012 may dispense any suitable number of drops of the fluid 1006 to particular locations on a surface of the substrate 1002, at any suitable location and drop size or volume, during any suitable number of dispensing passes. The fluid 1006 may be dispensed according to a determined drop pattern to optimize fluid 106 usage, minimize the presence of air gaps in the cured gratings, and/or precisely control the residual layer thickness (RLT) of the dispensed fluid.

After fluid dispense, the stage 1004 may move to a next station, at which an imprint mechanism 1016 operates to apply a template 1008 to the fluid 1006 that has been dispensed onto a surface of the substrate 1002. The template 1008 may be applied to create one or more desired surface feature 1024 (e.g., grating(s)) on a surface of the substrate 1002. In some implementations, the fluid dispenser and imprinting are performed according to a drop-on-demand Jet and Flash Imprint Lithograph (J-FIL) technique to dispense the fluid 1006 and imprint the desired pattern(s) into the fluid 1006, to create surface feature(s) such as diffraction grating(s).

In some implementations, after imprinting, the stage 1004 may move to a next station, at which a curing mechanism 1022 performs one or more operations to cure fluid 1006 or solidify the dispensed fluid in the shape of the imprinted patterns. Such curing may be through any suitable technique, according to the particular fluid 1006 being used, such as the application of heat, radiation (e.g., UV light), and/or pressure.

In some implementations, the stage 1004 may move to a station that includes a drop spacer dispenser 1018. The dispenser 1018 may dispense one or more drops of spacer material fluid 1026 onto predetermined, suitable location(s) on a surface of the substrate 1002. The fluid 1026 may be dispensed onto location(s) that are included in the previously created surface patterns (e.g., diffraction gratings) and/or onto location(s) that are outside the surface patterns. The fluid 1026 may be composed of a different material than the fluid 1006, given that different properties may be desirable for the spacer material relative to the material used to create the surface grating(s) 1024. In some implementations, the fluid 1026 may be the same as fluid 1006.

At a next station, a curing mechanism 1030 may cure the spacer drops 1026 to solidify the drops into spacers 1034 on the surface of the substrate 1002. In some implementations, the curing mechanism 1030 may be the same as the mechanism 1022 used to cure the fluid 1006, in examples where the fluid 1006 and fluid 1026 are curable using the same techniques. Alternatively, a different mechanism may be used to optimally cure the fluid 1026 using the appropriate curing technique(s), such as the application of ultraviolet or visible light, heat, pressure, and so forth. In some implementations, the spacer drops can be at least partly cured as they are being dispensed onto the substrate 1002, and then finally cured after they have arrived on the surface. Alternatively, the spacer drops can be cured after they have been dispensed onto the surface of the substrate 1002. In some implementations, the spacer fluid 1026 may be allowed to flow for a predetermined amount of time to achieve the desired spacer shape and/or height, prior to curing. Various implementations of spacer(s) are described further below.

In one example, crosslinking the prepolymer material includes exposing the prepolymer material to actinic radiation having a wavelength between 310 nm and 410 nm and an intensity between 0.1 J/cm² and 100 J/cm². The method can further include, while exposing the prepolymer material to actinic radiation, heating the prepolymer material to a temperature between 40° C. and 120° C.

In some implementations, the system 1000 includes a control device 1020 that is communicatively coupled to various other devices of the system 1000 that perform actions on the substrate 1002 and to manufacture the optical device, including the stage 1004, the fluid dispenser 1012, the imprint mechanism 1016, the curing mechanism 1022, the spacer drop dispenser 1018, the spacer curing mechanism 1030, and so forth. The control device 1020 can send signals to the various other devices to control their operations. In some implementations, the control device 1020 is a computing device of any suitable type, which includes at least one processor and memory. The memory can store a computer program that includes instructions which, when executed by the at least one processor, cause the processor(s) to perform operations to control the various device(s) of the system 1000 during the manufacturing process.

Although FIG. 10 shows an example of a system 1000 that includes a single instance of each type of manufacturing device, other implementations are possible. For example, the system 1000 may include multiple stations to create the surface feature(s) (e.g., gratings and/or to create the spacer(s) 1034, e.g., to improve throughput of the system 1000 and speed the manufacturing process. The system 1000 can also include various other types of devices and stations that perform other operations. For example, an etching mechanism may operate to etch the surface feature(s) 1024 after they have been cured, to create more refined nanostructures in the gratings. The system 1000 may also include a station that singulates (e.g., cuts) the substrate 1002 into desired eyepiece shape(s) for the optical device, e.g., after the surface feature(s) and/or spacer(s) have been created. The system 100 can also include a station that inspects the substrate 1002 at one or more stages in the manufacture, such as through operation of an imaging camera or other suitable diagnostic tool(s). After the substrate 1002 has been singulated into the desire shape(s), the singulated substrate (e.g., waveguide) portion(s) can be stacked to create a waveguide stack in which the separation between the various waveguides is maintained by the spacers 1034.

The substrate 1002 can be composed of any suitable material, including various suitable glasses and polymers. For example, the substrate can be composed of an inorganic amorphous material (e.g., dense tantalum flint glass TADF55, quartz, etc.), a crystalline material (e.g., LiNbO3, LiTaO3, SiC, etc.), high index polymers (e.g., containing sulfur, aromatic groups, etc.), and/or other polymer materials such as polycarbonate (PC), polyethylene terephthalate (PET), and so forth.

Implementations support the use of various suitable types of photoresist fluid 1006. In some implementations, the resist is a polymer-based resin with incorporated nanoparticles (NPs) of a higher index material. Alternatively, the resist can be a polymer-based resin without incorporated NPs. Incorporation of NPs may increase the overall refractive index of the material, which provides advantages in more closely matching the refractive index of the substrate as described herein. However, incorporation of NPs may also cause Rayleigh scattering of light in the resist. Accordingly, the choice of using a resist that includes NPs, or that omits NPs, may be based on a balancing of considerations, e.g., higher index vs. more scattering. For example, a resist with refractive index 1.6 or 1.7, and without NPs, may provide optimal performance that provides for a higher index (e.g., closer to that of the substrate) while avoiding the scattering that would be caused by the presence of NPs.

Organic (meth)acrylate monomers and oligomers typically have a refractive index of approximately 1.5 at a 532 nm wavelength. Sulfur atoms and aromatic groups, which both have higher polarizability, can be incorporated into these acrylate components to boost the refractive index of the formulation. This effect is limited due to the fluid viscosity restriction of less 20-25 cP for the inkjet process, and by the refractive index upper limit of the sulfur containing molecules. This approach yields jettable and imprintable resists with a refractive index as high as 1.72 at 532 nm wavelengths of light.

Incorporating inorganic NPs such as ZrO₂ and TiO₂ can boost refractive index significantly further. Pure ZrO₂ and TiO₂ crystals can reach 2.2 and 2.4-2.6 index at 532 nm respectively. For the preparation of optical nanocomposites of acrylate monomer and inorganic nanoparticle, the particle size is smaller than 10 nm to avoid excessive Rayleigh scattering. Due to its high specific surface area, high polarity, and incompatibility with the cross-linked polymer matrix, ZrO₂ NPs have a tendency to agglomerate in the polymer matrix. Surface modification of NPs can be used to overcome this problem. In this technique, the hydrophilic surface of ZrO₂ is modified to be compatible with organics, thus enabling the NP to be uniformly mixed with the polymer. Such modification can be done with silane and carboxylic acid containing capping agents. One end of the capping agent is bonded to ZrO₂ surface; the other end of capping agent either contains a functional group that can participate in acrylate crosslinking or a non-functional organic moiety. Examples of surface modified sub-10 nm ZrO₂ particles are those supplied by Pixelligent Technologies™ and Cerion Advanced Materials™. These functionalized nanoparticles are typically sold uniformly suspended in solvent as uniform blends, which can be combined with other base materials to yield resist formulations with jettable viscosity and increased refractive index.

The surface features 1024 created on one or more surfaces of the substrate 1002 can include diffraction gratings that are optically functional to affect the light passing through the substrate. Such diffraction gratings can include, but are not limited to, an in-coupling grating (ICG), an out-coupling grating (OCG), an orthogonal pupil expander (OPE), an exit pupil expander (EPE), a combined pupil expander (CPE), and/or other types of gratings. The substrate, and the manufactured eyepiece, can include any suitable number and type of such gratings in any suitable combination to achieve the desired optical performance.

The drop spacer dispense mechanism 1018 can include any suitable apparatus to dispense drops of the fluid 1026 with the desired volume. In some implementations, the mechanism 1018 includes one or more PicoPulse™ dispensing components. The mechanism 1018 can include one or more piezo dispenser heads to which a removable valve body is attached. In some implementations, the dispenser has a very small orifice (e.g., 20 μm or 50 μm) to attain the desired results. Small orifices are key to obtaining small spacer drop sizes, to create spacers that are sufficiently small as to not obstruct the field of view of the user when the optical device is being used in an AR system, for example, in which the user is permitted to view the outside world through the transparent waveguide stack.

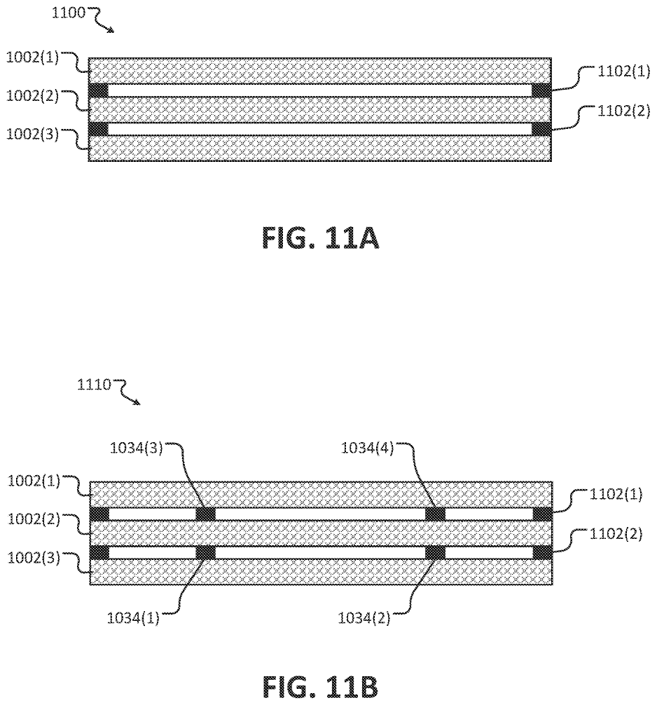

FIG. 11A illustrates an example schematic 1100 of a waveguide stack without spacers. The stack may include any suitable number of waveguides 1002. In this example, the stack includes three waveguides 1002(1), 1002(2), and 1002(3), as singulated instances of the substrate described above. The waveguides may include suitable surface features not shown, such as diffraction gratings. Different waveguides may convey light of different wavelength ranges. For example, different waveguides may convey red, green, and blue light. In some instances, different waveguides may convey light for images or graphics to be output at different depth planes, such that the conveyed images or graphics appear to the user to be at different distances from the user.

In this example, the waveguide stack is sealed on the edges with a sealant 1102 between the various waveguide layers. The sealant may operate to mechanically stabilize the stack and prevent external contaminants from entering the gap between layers. The sealant may also be blackened to absorb stray light. However, even with a sealant on the edges of the stack, the layers of the stack may, over time, bend or otherwise deform such that the gap may grow less consistent in height over time. In extreme cases, the waveguides may come into contact with each other if the gap narrows too much, dramatically degrading the performance of the optical device.

FIG. 11B illustrates an example schematic 1110 of a waveguide stack with spacers 1034. In this example, at least two spacers 1034 are situated between the layers to mechanically stabilize the stack and ensure that the gap height remains consistent over time. Implementations support the use of any suitable number of spacers 1034 at suitable locations on one or more surfaces of the waveguide(s) 1002. Spacers may also be added to control gaps between additional layers (not shown), such as cover glass that may exist on either side of the waveguide layers.

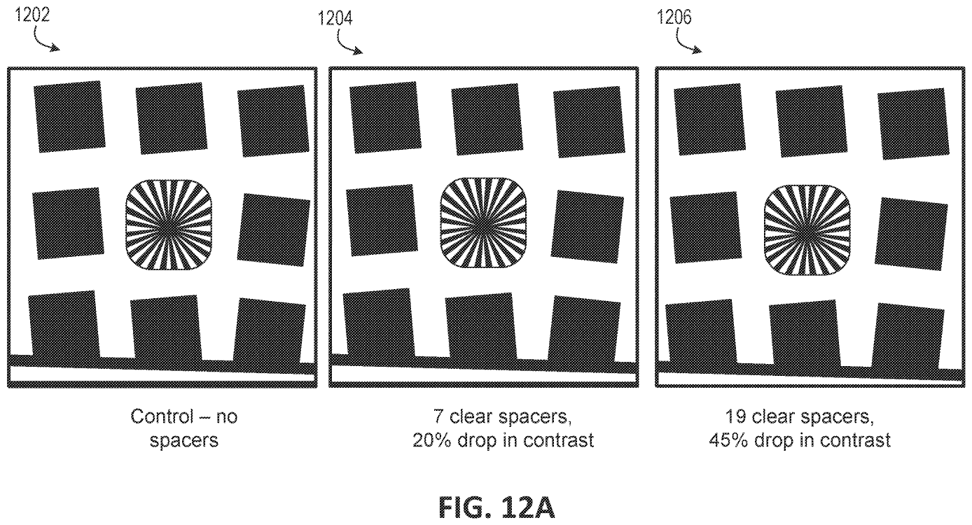

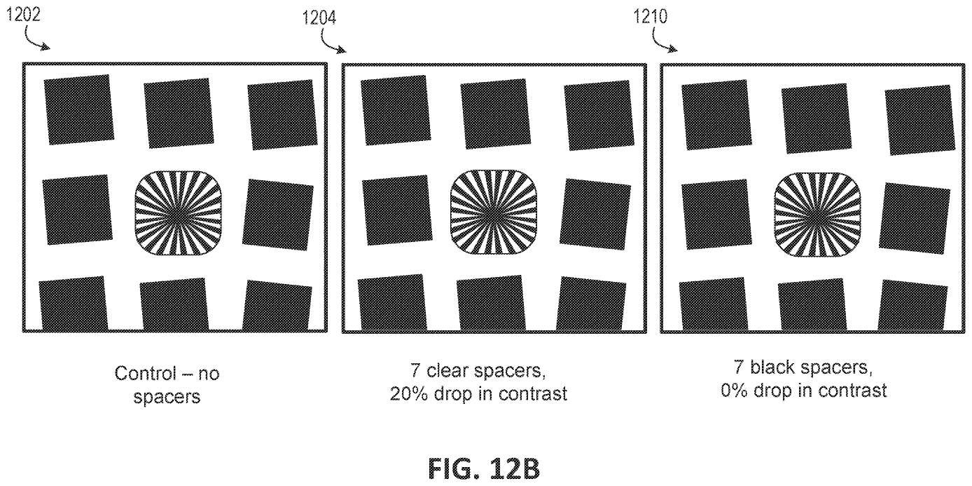

FIGS. 12A and 12B are test images illustrating performance of an optical device with different spacer configurations. FIG. 12A shows various images 1202, 1204, and 1206 generated to gauge the performance of an optical device manufactured using spacers made of a transparent material. In this example, the testing was performed using a transparent NEA 123 adhesive made by Norland Chemicals™. This particular material was chosen for its high viscosity (200K cps), so that it would not flow or wick into the gratings while maintaining an acceptable height of the spacers.

Image 1202 is a control image made using a device without spacers. Image 1204 is a test image made using an apparatus that included seven spacers made of the transparent (e.g., clear) material. This image 1204 shows an approximately 20% drop in contrast compared to the control image 1202. Image 1206 is a test image made using an apparatus that included 19 transparent spacers. This image 1206 shows an approximately 45% drop in contrast compared to the control image 1202. As illustrated by these images, adding transparent spacer material to the optical element results in a decrease in image contrast, with the decrease being directly proportional to the number of spacers added. This is caused by the phenomenon of the TIR light scattering off the spacer, such that the spacer optically replicates the light within the eyepiece, leading to a dramatic decrease in contrast the more spacers are used. The transparent spacer material thus contributed to a scattering of the light conveyed by the waveguides, thus diminishing overall contrast.

For a next round of testing, a black spacer material was used instead of the transparent material. FIG. 12B shows test results generated using spacers made of a black 937LED9074 ink manufactured by Ruco™. Image 1202 is the control image with no spacers. Image 1204 is again the image generated with seven clear spacers, showing the 20% drop in contrast. This can be compared with image 1210, which was generated with seven black spacers. This image 1210 shows no appreciable drop in contrast relative to the control image, and thus no degradation in image quality. In some implementations, the use of blackened spacer material is preferable to the use of transparent material, given that the transparent spacers can alter the way the light flows within the waveguide. Blackened spacers avoid such effects given that the black material absorbs any light that is incident on the spacer. Also, given that the spacers are sufficiently small in size, they also do not interfere with the light passing through the waveguide from the outside world, in examples where the optical device is an AR or MR device. Accordingly, the user of the device does not notice the presence of the black dots operating as spacers.

The impact of the spacer material on optical transmission and haze was also determined. As used herein, “optical transmission” generally refers to a percentage of incident light that passes through an optical device (e.g., a spacer) as a function of wavelength. In the context of eyepieces or wearables, this corresponds to the ability to see the world and how dim the world appears. In some cases, optical transmission is given in terms of percent of incident light that passes through to the eye or a detector as a function of wavelength, or as a single number which is the integral of the transmission value at each wavelength weighted by the human visual response (the photopic curve). As used herein, “haze” generally refers to the scattering of light within an optical device by objects or surfaces in its path (e.g., a spacer) away from its intended propagation direction, resulting in stray light that can reduce contrast and degrade image quality. Haze can be measured by sending a light beam through the device and then assessing how much light is detected away from the main beam direction. More haze means more scattered light, which is apparent as poorer contrast and undesirable visual artifacts, such as halos around light sources.

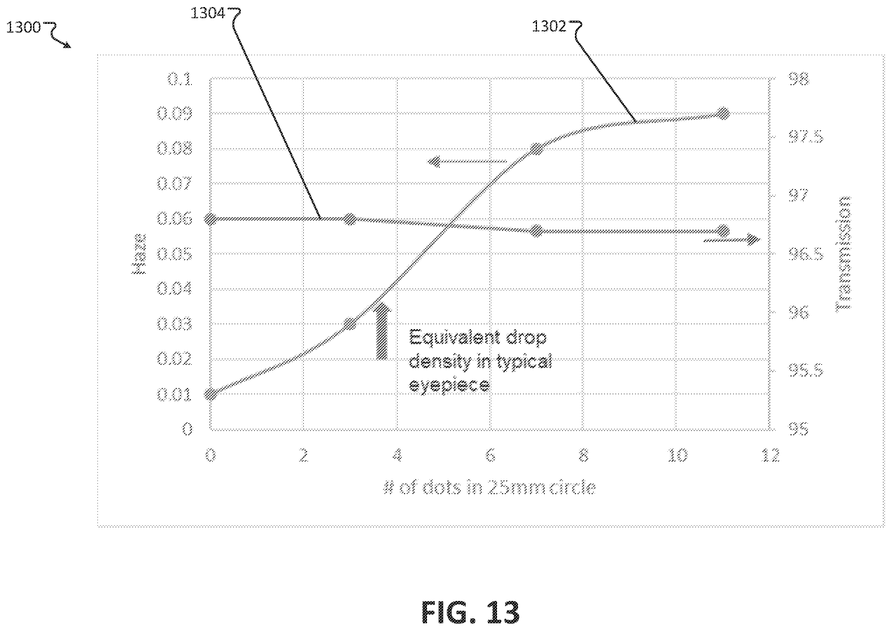

Samples were generated by dispensing drops within, for example, a 30 mm diameter substrate area and the optical performance of the generated samples was measured on a Hunterlabs™ hazemeter. The results are illustrated in FIG. 13. In plot 1300 of FIG. 13, the horizontal axis measures the density of spacers (e.g., a number of spacer dots within a 25 mm circle). The vertical axis on the left tracks haze (%), and the vertical axis on the right tracks optical transmission (%). Transmission as a function of density is shown by line 1304, and haze as a function of density is shown by line 1302. Results show that there is no appreciable impact on optical transmission and that for the spacer density used within the eyepiece, the haze level of less than 0.04 is within the noise of the baseline measurements of the spectrophotometer. Clear substrates give values between about 0.01% and about 0.05%.

As discussed above, the use of black spacers provides advantages to absorb the light that is incident on the spacer, to avoid undesired diffraction events off the spacer that reduce the performance of the device. Alternatively, other colors may also be used to selectively absorb certain wavelength ranges of light. For example, in a waveguide stack different waveguides may be conveying, through TIR, different wavelength ranges of light. As a particular example, a stack can include three waveguides that respectively convey red, green, and blue light. In such scenarios, the spacers that are on the surface of a particular waveguide may be composed of a material that absorbs those wavelengths of light that are being conveyed by that waveguide. For example, a red-, green-, or blue-conveying waveguide may have, on its surface, spacers that respectively absorb red, green, or blue light wavelength ranges. Given that black absorbs all visible wavelengths with similar efficiency, and for the sake of lowering cost and increasing manufacturing efficiency, it may be simplest to just use black spacers.

Moreover, because the black spacers absorb light that would otherwise travel through the waveguide and be coupled out to the user's eye, it is advantageous to use as few spacers as possible to minimize the amount of light being lost to absorption. Similarly, it may be advantages to place the spacers on regions of the waveguide that are less important (e.g., not in the optical path) for conveying the image(s) to be presented to the user. Such spacers can be added in places that might not be directly in front of the user's pupil, that is: (a) hidden behind other components such backlit infrared LEDs used in the eye illumination layer which is closest to the user's eye; (b) more concentrated around the non-visible edges of the eyepiece, or (c) distributed in a patterned rectilinear, or polar coordinate concentric about the center of the CPE/EPE, or distributed a bit randomly. Spacers can also be of different volumes dispensed in order to get same or varying height with varying base area depending on how the spacer material spreads, and the like.

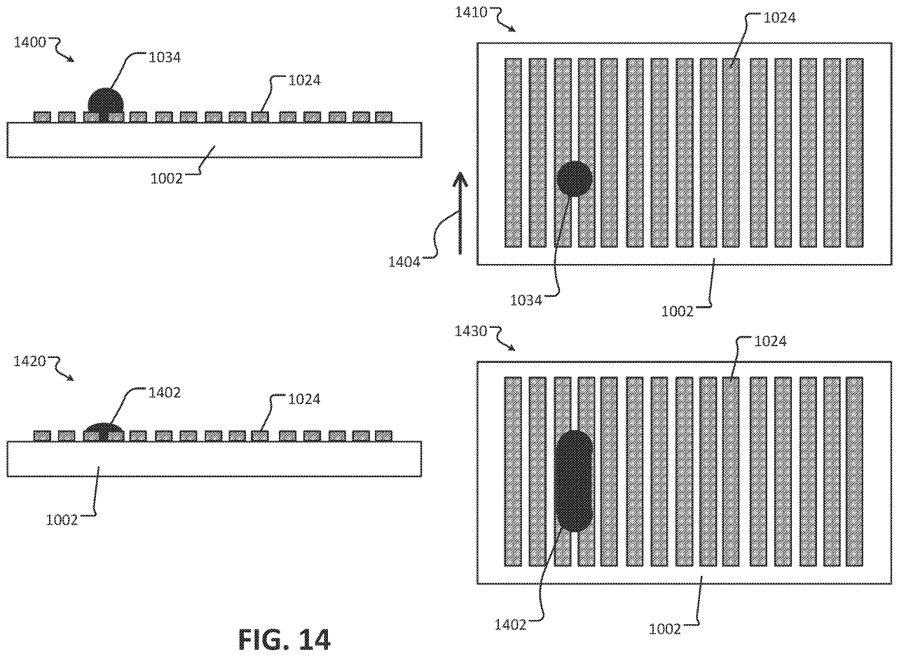

FIG. 14 illustrates example schematics of a substrate 1002 with dispensed spacer material. Various materials may be used to create the spacers, and different suitable materials may exhibit different properties. In implementations where the spacers are composed of a viscous material, the dispensed spacer drop may flow after coming into contact with the substrate 1002. In some instances, when the spacer drop is dispensed onto a portion of the substrate 1002 that includes a surface feature (e.g., diffraction grating), the drop flow may be in the direction of the surface feature, such as along a channel formed by the surface feature.

In the examples shown in FIG. 14, schematic 1400 shows a side view of a substrate 1002 onto which a spacer drop 1034 has been dispensed, onto a region that includes a surface feature 1024. Schematic 1410 shows a top-down view of the substrate. In this example, the spacer drop may have recently been dispensed and has not yet had time to flow, and has not yet been cured. Schematic 1420 shows a side view of the substrate 1002 after some time has passed since the dispensing of the spacer drop 1034. In this example, the viscous drop has flowed such that the height of the flowed drop 1402 is lower than the height of the originally dispensed drop 1034. Schematic 1430 shows a top-down view of this scenario, in which the drop 1402 has flowed along a direction 1404 defined by the surface feature(s) onto which the drop is dispensed, e.g., along a channel formed by the surface features. In some implementations, after the drop is dispensed, a predetermined amount of time may be allowed to elapse prior to curing, to allow the drop to flow in this matter. In such examples, the spacer after curing may have an elongated or elliptical shape, with a lower height. In this way, implementations can allow the spacer geometry to be more finely tuned, for example to have a desired height to ensure a desired gap height between waveguides in the finished waveguide stack.

When drops of spacer material are dispensed onto a featureless surface, such as bare glass without surface features, a dispensed drop of spacer material may spread outward on the surface with substantially radial symmetry outside after being dispensed. In contrast, the manufactured waveguides can have surface gratings on the active areas. The particular geometries of the gratings, for example the depth of channels formed by the gratings, can vary from location to location within the active areas. For example, surface features may have regions with deeper channels and regions with more shallow channels. The eventual shape of the dispensed spacer material after it has flowed and been cured can be strongly dependent upon the grating geometries in the locations where the drops are dispensed. In shallower regions, the spacers form more radially symmetric, spherical shapes. In deeper regions, there is a more preferential spreading along the grating direction 1404, to form spacers with a more elongated, elliptical, and/or cigar shape, as shown in schematic 1430.

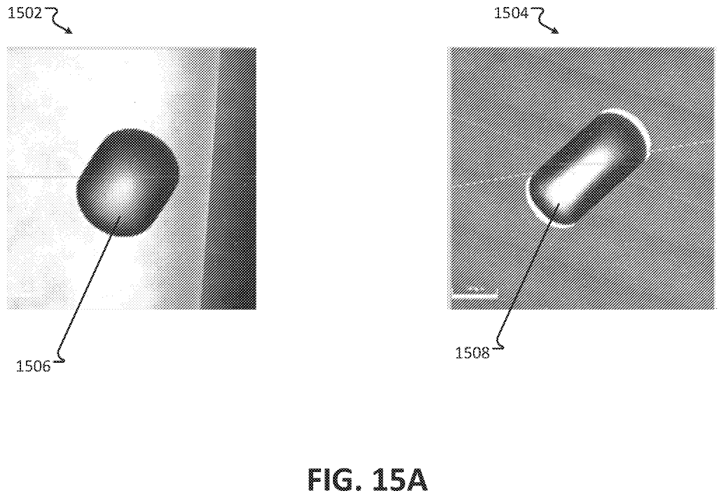

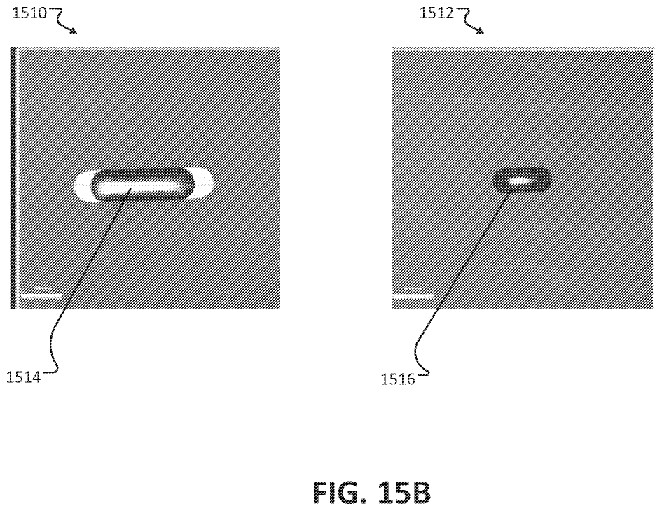

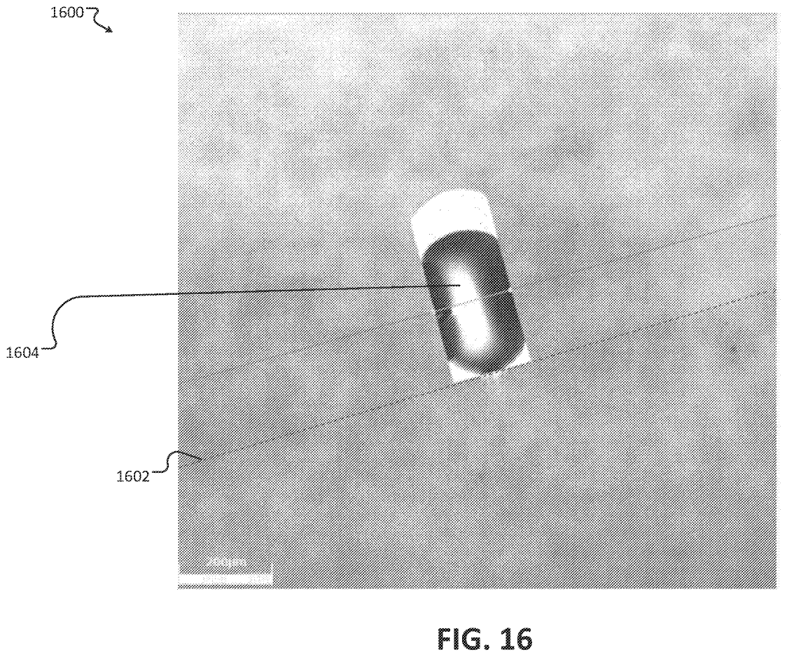

This spacer shape formation is further illustrated in FIGS. 15A, 15B, and 16, which show test images of a substrate 1002 with dispensed spacer material 1402. In FIG. 15A, image 1502 shows a drop 1506 that has been dispensed onto a region of shallow features. This drop 1506 has flowed somewhat along the axis of the features, and has also spread in a direction perpendicular to the feature axis. Image 1504 shows a drop 1508 that has been dispensed onto a region of deeper features than those in image 1502. The drop 1508 has flowed further along the axis than drop 1506, and exhibits less spreading in the perpendicular direction. In this way, the underlying grating structure has an effect on dispensed drop shape, such that deeper gratings result in greater preferential spread of the drops along the grating axis.

The differences in spreading can also result in different drop heights for the resultant drops after spreading has occurred. In particular, drops that are able to spread further or longer also exhibit reduced height, given that the volume of the drop remains constant. Accordingly, in implementations where consistent height among spacers is desired, for spacers in different regions having different surface feature geometries, the volume of the drops may be varied based on location where the drops are dispensed. For example, drops that are dispensed onto a region of deeper surface features are expected to flow further, and the volume of such drops may be increased relative to drops that are dispensed onto other regions with shallower surface features. In this way, implementations provide for the customizing of drop volumes by location, with little or no impact on dispensing speed or throughput of the manufacturing process.

In addition to drop volume, surface energy of the substrate material can also affect drop height by controlling how the dispensed spacer material spreads. For example, when the same spacer material is dispensed onto an untreated silicon surface and a fluorinated silicon surface, the fluorination results in a decrease in the surface energy of the substrate, thus increasing the contact angle of the spacer material on the substrate. Similarly, a surface of a patterned diffractive optics area can be treated with a thin coating of conformally deposited fluorine-containing polymer material, such as 1H,1H,2H,2H-perfluorooctyltriethoxysilane or trichloro(1H,1H,2H,2H-perfluorooctyl)silane, using a batch vacuum or atmospheric pressure process with or without plasma assist and either at room temperature or a heated environment up to 120° C. This fluorinated material can also be functionalized on the surface of an inorganic material such as SiO₂ or TiO₂ deposited over the patterned area using a method such as chemical vapor deposition (CVD) (e.g., plasma-enhanced CVD (PECVD), atomic layer deposition (ALD), or atmospheric pressure PECVDO (AP-PECVD)) or physical vapor deposition (PVD) (e.g. sputter or evaporation) prior to the deposition of the fluorine-containing polymer material. This intermediate inorganic layer can be used to improve adhesion of the fluorine-containing polymer material to the diffractive pattern. Materials such as SiO₂ have a low refractive index and do not tend to change the optical key performance indicators at sub-10 nm coating thicknesses:

In some cases, a surface can be chemically functionalized so as to alter a contact angle of the dispensed material. Surface bonding agents can react and crosslink via silanol groups. Direct plasma application of 1H,1H,2H,2H-perfluorooctyltriethoxysilane or trichloro(1H,1H,2H,2H-perfluorooctyl)silane through, for example, atmospheric plasma deposition, as well as a low pressure vacuum based coating of 1H,1H,2H,2H-perfluorooctyltriethoxysilane or trichloro(1H,1H,2H,2H-perfluorooctyl)silane directly over the diffractive material can alter the surface energy and thus the contact angle, thereby changing the spacer dot height.

Possible phase separation of the different components present in the spacer drop material can also be a consideration. High viscosity materials, e.g., on the order of 100s of kilocentipoise (kcps) do not suffer from phase separation when dispensed on gratings (e.g., diffraction gratings). However, when the viscosity drops to into the realm of 10s of kcps or lower, phase separation can start to occur. Specifically, the low viscous base material of the spacer fluid tends to separate from the pigment and/or other higher viscosity components. If the surface energy of the gratings is reduced, the phase spreading over the grating can be reduced or suppressed. This is illustrated in FIG. 15B, which shows test images generated from similar drops of spacer material dispensed onto an untreated surface (image 1510) and onto a fluorinated surface (image 1512). Image 1510 shows the drop 1514 with a bright region in which the faster moving low viscosity material has separated from the slower moving higher viscosity material that contains the black pigment. In image 1512, there is little or no phase separation in drop 1516, as the low energy fluorinated surface pins the low viscosity component and prevents it from separating from the higher viscosity material.

Just as patterns can be used to preferentially move fluid in a particular direction (e.g., along the gratings), the fluid may also be confined, in whole or in part, using patterns that are created on the surface to block or control the flow. FIG. 16 shows a test image 1600, in which a dispensed drop 1604 is prevented from flowing in a particular direction by the presence of a confinement feature 1602. In this example, the feature 1602 (the dashed black line in the image) is a contiguous grating path that prevents the flow of the spacer material across the path.

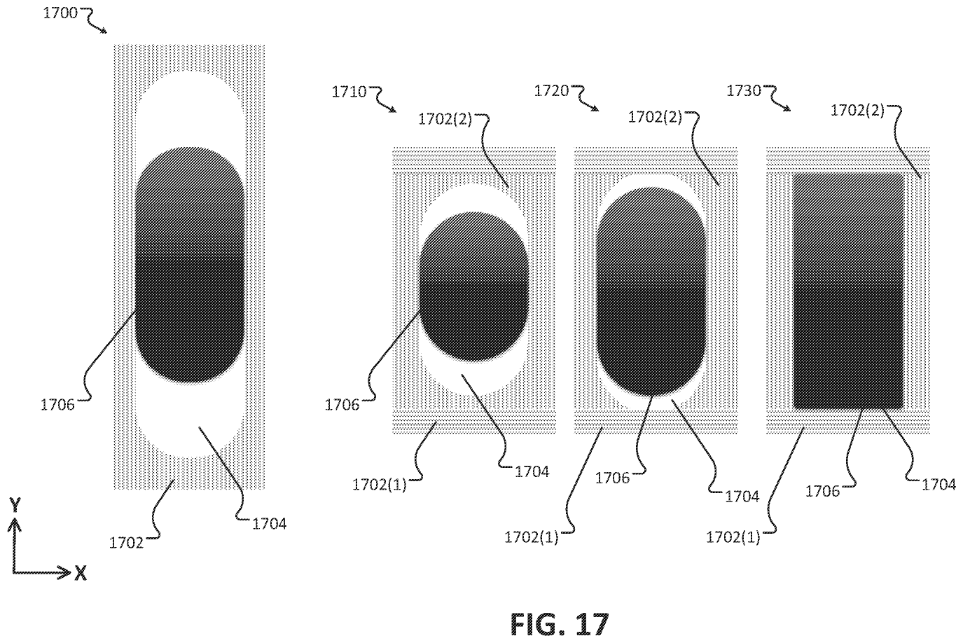

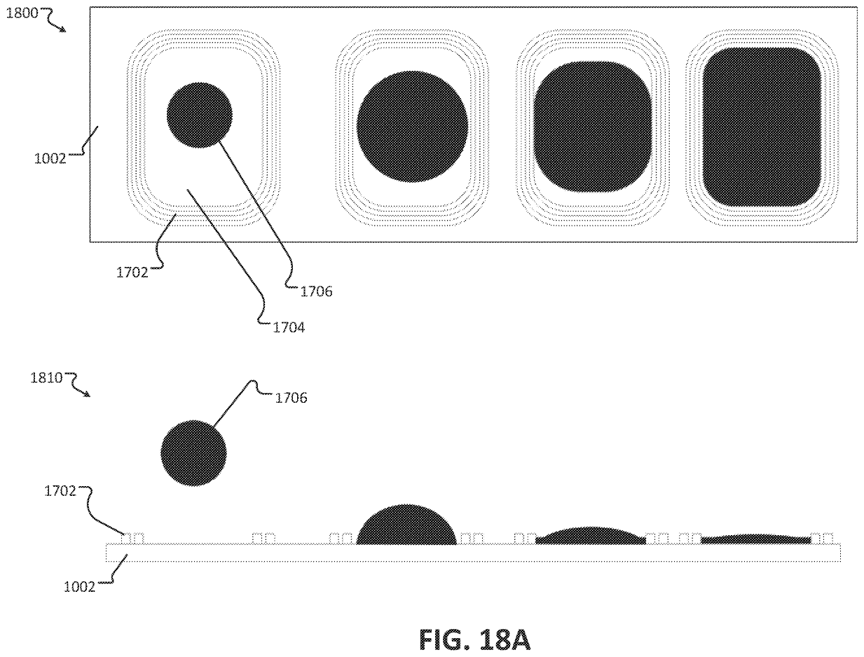

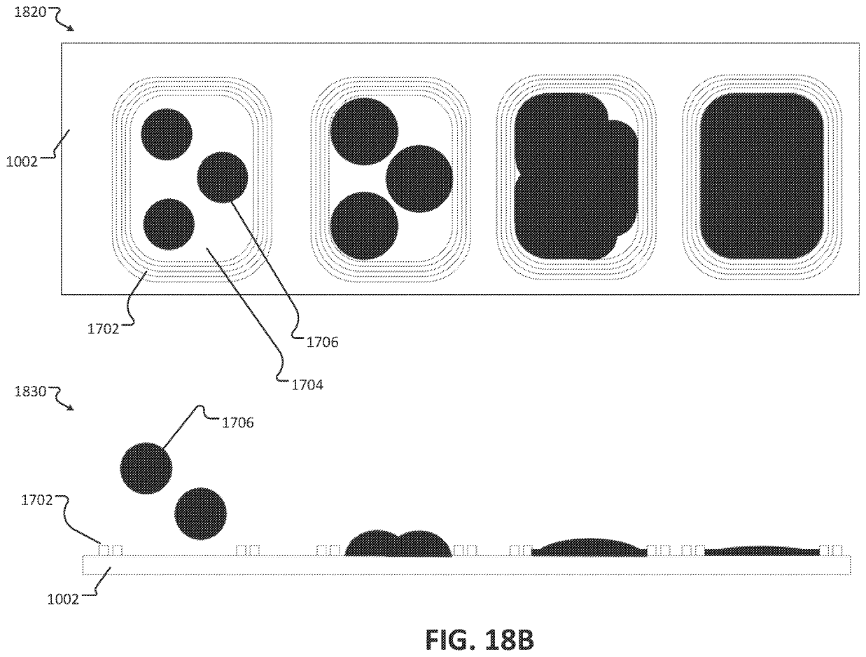

FIGS. 17, 18A, and 18B are example schematics of a substrate with confinement gratings to control the flow of spacer material. Such confinement gratings may be separate from the diffraction gratings used to control the light in the waveguide. Alternatively, the confinement gratings may be part of the diffraction gratings and/or included in a common, contiguous surface feature.

FIG. 17 shows various examples of confinement gratings used to confine or otherwise control the flow of the spacer material on the surface of the substrate. Schematic 1700 shows a confinement grating 1702 that surrounds a featureless confinement region 1704 into which a spacer drop 1706 has been dispensed. As shown in this example, the drop 1706 has flowed somewhat within the region 1704, the confinement grating 1702 presents the drop 1706 from flowing outside the region 1704. The grating 1702 may be designed to create a region of a particular size and/or geometry, such that a drop 1706 of particular volume and viscosity can flow a controlled amount in a controlled direction, thus controlling the height of the eventual spacer created by curing the drop 1706 after it has flowed.

In the example of schematic 1700, the grating 1702 includes features in one direction, e.g., in the Y-direction as shown, parallel to the direction in which the drop 1706 flows, to restrict the spacer material to flow along the long axis of the grating 1702. The grating 1702 can also include features in multiple directions to provide more fine-tuned control of the drop flow. Schematic 1710 shows such an example in which the confinement grating 1702 includes a grating 1702(1) with features that run in an X-direction perpendicular to the direction in which the drop is permitted to flow, and a grating 1702(2) in the Y-direction. The use of the cross-wise 1702(1) grating may block the spacer fluid from flowing too far into the features of the 1702(2) grating. Schematic 1720 shows another example, in which the grating 1702(1) forms part of the boundary of the confinement region 1704, in contrast to the example of schematic 1710 in which the region 1704 is bounded on all sides by one grating 1702(2). The gratings can also be arranged to create a confinement region of desire shape and size. For example, schematic 1730 shows an arrangement in which the confinement region 1704 is substantially rectangular. The drop volume and viscosity can be selected to control to what extent the drop fills the confinement region 1704. In the example of schematic 1730, the drop has flowed to substantially fill the region 1704, in contrast to the other examples in which the drop partly fills the region 1704.

In some implementations, the confinement region 1704 is substantially featureless, e.g., a flat substrate surface that does not include diffraction grating. Alternatively, the confinement region 1704 can be an area of the substrate surface that includes an active area, e.g., a diffraction grating. In such implementations, the confinement grating(s) 1702 can be superimposed onto the underlying diffraction grating(s) in one or more imprinting steps. In general, the confinement grating(s) 1702 can be created on the surface(s) of the substrate using the same techniques as used to create the diffraction grating(s) or other optically active regions on the substrate, in a same manufacturing step or in separate manufacturing steps.

FIGS. 18A and 18B illustrate examples in which the confinement region 1704 is substantially free of diffraction gratings or other surface patterns, such that the spacer drop 1706 tends to spread symmetrically outward until it begins to encounter the confinement grating 1704. In FIG. 18A, schematic 1800 shows a top-down view of a substrate 1002 that includes a confinement grating 1702 surrounding a confinement region 1704. The initially spherical drop 1706 is dispensed into the confinement region 1704 and, as shown in the schematics from left to right, the drop 1706 gradually flows and spreads to fill the confinement region 1704. In this way, the final shape and size of the spacer is determined by the geometry of the confinement grating 1702, which operates to shape and confine the spacer fluid. The height of the spacer thus created depends on the shape and size of the confinement region 1704 as well as the volume of fluid in the drop 1706. Schematic 1810 shows a side view of the same example, showing the drop 1706 dispensed into the region 1704 and flowing gradually to fill the region confined by the grating 1702.

FIG. 18B shows a similar example, in which multiple drops 1706 are dispensed into the region 1704 to ensure the region is filled. Schematic 1820 shows a top-down view of this scenario, with three drops dispensed to fill the confinement region 1704. Schematic 1830 shows a side view of this example. Any suitable number and volume of spacer drops can be dispensed to create the desired spacers. Similarly, the viscosity of the drops can be selected such that the drops flow sufficiently to fill the confinement region 1704. If the drop volume are too small relative to the area to be filled, or if the drops have very high viscosities, multiple drops may be employed to fill out the defined area in which the spacer is to be formed.

In general, the confinement grating(s) 1702 can be configured to create confinement region 1704 in which the spacer is to be formed with the desired geometry—height, width, length, etc. Although these examples show confinement grating(s) that entirely bound a confinement region, implementations are not so limited. In some implementations, a confinement region 1704 can be defined that is unbounded on one or more sides, such that the flow of the spacer fluid is blocked in certain direction(s) and not blocked in other direction(s). In such examples, the viscosity of the fluid may determine to what extent the fluid flows in a particular direction instead of being deliberately blocked by a feature such as the confinement grating 1702.

In the examples above, the process for creating a spacer on the surface of a substrate includes dispensing the spacer drop onto the surface of the substrate, waiting a suitable amount of time for the drop fluid to flow to the desired extent, and then curing the flowed drop to solidify the drop fluid and create the spacer. Implementations are not so limited, however. In some implementations, the drop can be fully, or at least partly, cured as it is falling onto the surface. This can also be described as in-flight spacer curing.

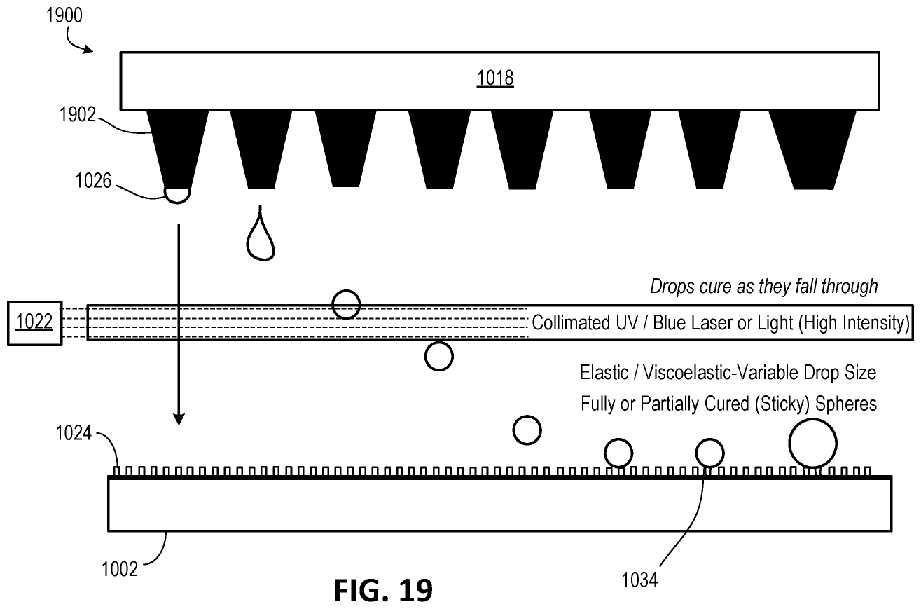

FIG. 19 illustrates an example schematic 1900 of a manufacturing apparatus for dispensing spacer material with in-flight curing of the spacer material. This apparatus may be a component of the system shown in FIG. 10.

As shown in this example, the spacer fluid dispensing mechanism 1018 can include any suitable number of drop dispensers 1902. The orifice of the dispenser, and the dispenser geometry generally, can be configured to dispense drops 1026 of a desired volume. In this configuration, the spacer curing mechanism 1022 can be arranged to irradiate the drops as they fall from the dispenser(s) 1902 toward the surface of the substrate 1002. For example, the curing mechanism 1022 can be arranged such that the drops 1026 fall through a space that is being irradiated by collimated ultraviolet light, a blue laser, or some other high intensity light that is suitable to cure the material that composes the spacer fluid drops 1026.

The drops 1026 that arrive at the surface of the substrate 1002 can be already partly, or wholly cured when they reach the surface as cured spacers 1034. This may be more suitable in instances where the spacers 1034 are to be placed into regions that include an active surface such as a diffraction grating 1024, as shown in this example. The advantages of this are described further below. Fully cured drops may simply rest on the surface as substantially spherical spacers 1034. Partly cured drops (e.g., sticky drops) may continue to flow somewhat after they reach the surface, and/or their stickiness may provide advantages for stabilizing the spacer to the surface and/or stacking spacer drops atop other spacer drops to achieve a desired spacer height, as described further below.

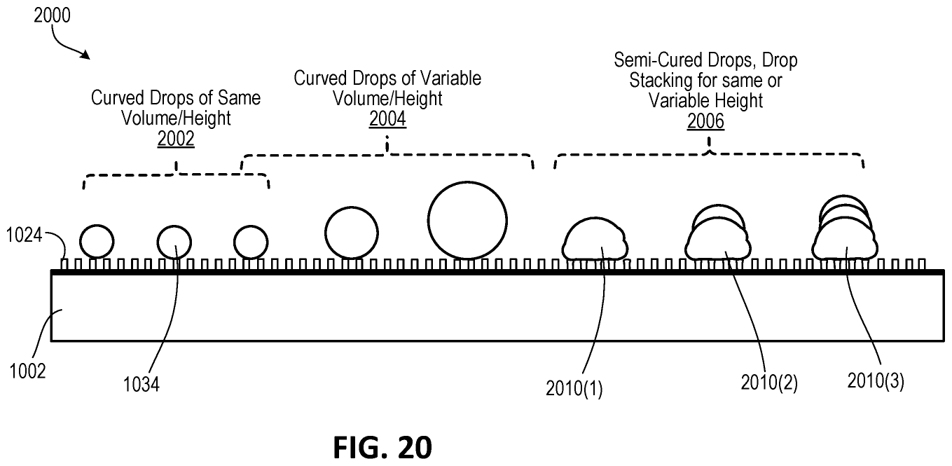

FIG. 20 illustrates an example schematic 2000 of spacer material dispensed onto a substrate 1002, into a region that includes surface feature(s) 1024 (e.g., diffraction gratings). In this example, the spacers have been wholly, or partly, cured before reaching the surface. In an area 2002, wholly cured drops 1034 of the same size, or substantially similar size, have been deposited onto the diffraction grating 1024 to create spherical spacers. In an area 2004, wholly cured drops 1034 of varying size (e.g., different volume and/or height) have been deposited onto the diffraction grating 1024 to create spherical spacers of different heights. In an area 2006, partially cured drops 2010 have been deposited onto the diffraction grating 1024. In a first example, a partially cured single drop 2010(1) is created on the surface. In a second example, two partially cured drops 2010(2) are dropped one atop the other to create stacked drops. In a third example, three partially cured drops 2010(3) are dropped on top of one another. Such drop stacking can be used to create spacers of a desired height. Because the drops are partially cured, they can stick to one other and provide mechanical stability for the stack of drops, and the bottom drop can adhere to the surface and/or the grating features.

As discussed above, controlling gap thicknesses to maintain a constant gap in a waveguide stack of flat or curved eyepiece waveguide substrates, or to intentionally vary the gap spacing to curve a flat eyepiece waveguide substrate, allows the waveguide stack to operate as an optical device with higher performance characteristics than traditional device, such as a larger field of view or better control of the focal depth of the virtual image. Previously used techniques that employ imprinted pillars as spacers, or post-imprint dispense of glass or polymer microspheres, are undesirable given that these types of structures can only occupy areas where there is no relief structure such as a diffraction grating (e.g., CPE, EPE, OPE, etc.). Traditional methods are also less desirable, given that they are limited in that they cannot precisely control the location of the structure to high precision. Creating spacers using polymer drops dispensed via inkjetting and cured in flight, such that the drop reaches the patterned surface fully or partially cured, and such that the spherical shape is at least partly maintained, can overcome these challenges and still be a viable in a large scale manufacturing approach. Controlled height spacers maintain a desired physical gap height between waveguides in a waveguide stack, e.g., between waveguides that convey light of different colors. This is crucial for designs that include inline ICGs to provide field of view increase, and/or in designs that employ curved waveguides where all colors of light may have the same focal depth (e.g., a desired gap variation of less than 2.5 μm per cm). Previously available solutions are not suitable to maintain gap separation between waveguides for these scenarios.

Moreover, the previously available technique of using spacers that are integrated pillars on the patterned surface creates a challenge to fill such holes (for molding pillars) during the patterning step, and pillar demolding over multiple patterned samples can be a problem during mass manufacturing. In addition, although using pre-defined pillars allows for accurate and desired placement of pillars, the pillars can occupy an area over a CPE where otherwise diffractive functional relief structures would have been created. Using CPE patterned areas for pillars can be avoided by using another approach in which glass or polymer microbeads or microspheres are dispensed over the active area (e.g., CPE, EPE, OPE, etc.) at a certain wt % (e.g., about 0.5 wt % to about 0.01 wt % of glass beads having a diameter in a range of about 20 μm to about 100 μm) dispersed in an evaporative surfactant (e.g., isopropanol or isopropyl alcohol). Atomizing such solutions over an area with a specific nozzle and cone distance can help maintain a certain bead or sphere density. However, the problem remains that there is little control over the exact microsphere placement location over the active area.

The techniques described herein overcome such problems by allowing for spacers that can be placed in an active area (e.g., CPE, EPE, OPE, etc.), with precise control over the location of the spacers, while allowing manufacture methods for high throughput, to allow creation of precision optical devices including waveguide stack designs that provide large field of view and also allow a wearable eyepiece to be thinner.

Using polymer spacer drops dispensed via inkjetting and cured in flight, such that the drop reaches the patterned surface fully or partially cured and such that the spherical shape is maintained, can overcome these challenges and still be a viable large-scale manufacturing approach. The spacer fluid is dispensable via inkjetting with the fluid selected for desired viscosity, surface tension, and/or other properties, with the inkjetting performed using a dispenser (e.g., nozzle) having the desired nozzle diameter to create drops of the desired volume and size. For example, a spacer fluid with a viscosity of 10 cps, surface tension of approximately 30 mN/m, dispenses with a drop diameter of 15 μm and 20 μm through nozzle diameters of 18 um to 28 um respectively.

In some implementations, the dispensing inkjet nozzle is a piezoelectric nozzle. The voltage and waveform used to dispense the fluid from a piezoelectric inkjet nozzle can have an effect on the drop volume and thus the sphere diameter of the resulting spacer once it has been (at least partially) cured in-flight. In-flight curing can be performed using a high energy collimated UVC/UVB/UVA/Blue wavelength broadband source or a narrow band source such as a LASER source. The collimated light ensures that no stray light is incident on the nozzle, which may be configured to have a UV guard and/or is moved away during curing, and that the drops reaching the relief structures are either fully cured or partially cured. Because the drops are at least partially cured by the time they reach the surface, this prevents the drops from filling in the channels or other geometric features of the surface relief structures (e.g., diffraction gratings) when the drops come into contact with the surface structures, and minimally affects the diffractive optical function of the surface structures while still maintaining the desired drop dispense accuracy and density across the surface of the substrate.

For example, for the same dispenser waveform, nozzle diameter (e.g., approximately 18-20 μm), and spacer fluid material, a change in dispenser voltage of 19V to 22V can result in drop volume of 1.5 pL to 2.5 pL, and drop diameter of 14 μm and 17 μm drop diameter respectively. Table 1 below gives an example of drop volume relative to drop diameter that is achievable using inkjetted pL drops, in which the relevant stack spacing in eyepiece waveguide stacks is typically less than 100 μm. Table 2 below shows the drop diameter of +/−1 μm change if the drop volume changes by +/−2 pL from the target drop volume of 50 pL, thus showing low sensitivity of drop diameter to drop dispense volume.

TABLE 1

| Drop volume (pL) | Drop volume (cubic μm) | Diameter (μm) |
|---|---|---|
| 1 | 1.00E+03 | 12 |
| 1.5 | 1.50E+03 | 14 |
| 2.5 | 2.50E+03 | 17 |
| 3.5 | 3.50E+03 | 19 |
| 10 | 1.00E+04 | 27 |
| 50 | 5.00E+04 | 46 |
| 100 | 1.00E+05 | 57 |
| 150 | 1.50E+05 | 66 |
| 200 | 2.00E+05 | 72 |
| 250 | 2.50E+05 | 78 |
| 300 | 3.00E+05 | 83 |

TABLE 2

| Drop volume (pL) | Drop volume (cubic μm) | Diameter (μm) |
|---|---|---|
| 48 | 4.80E+04 | 45 |
| 49 | 4.90E+04 | 45 |
| 50 | 5.00E+04 | 46 |
| 51 | 5.10E+04 | 46 |
| 52 | 5.20E+04 | 46 |

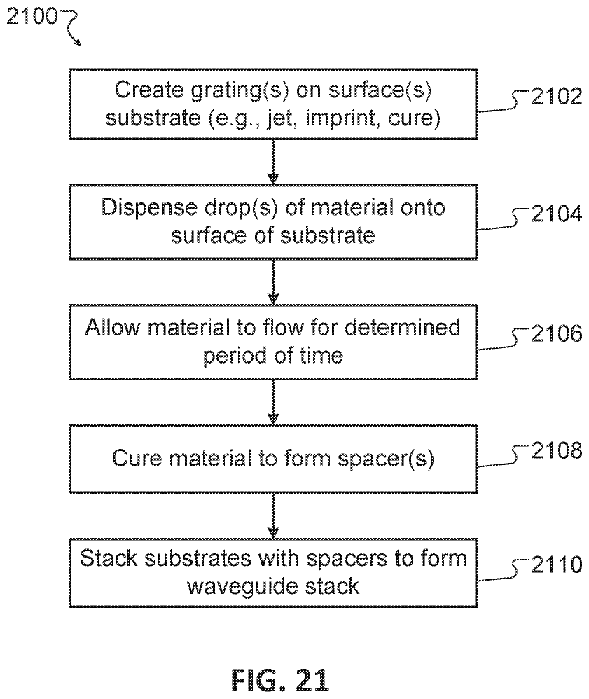

FIG. 21 is a flow diagram 2100 of an example process for manufacturing waveguide stacks to include spacers. Operations of the process can be performed in any suitable order, serially or in parallel, and may be divided into sub-operations. The operations may be performed by components of a system such as that shown in FIG. 10.

At 2102, various surface features such as diffraction gratings can be created on at least one surface of a substrate for a waveguide. As described above, creating the gratings for optically active areas on the wave guide can include jetting a suitable (e.g., polymer) fluid, applying a template to create the desired pattern in the dispensed fluid, curing the fluid using ultraviolet light or other suitable curing technique, and/or etching the cured patterns to modify the structures as desired. In some implementations, one or more confinement gratings can be created on one or both surfaces of the substrate, as described above.

At 2104, one or more drops of fluid may be dispensed onto at least one surface of the substrate to create the desired spacer(s). The spacer fluid can be dispensed onto active areas, e.g., that include diffraction gratings, or onto areas that do not include other surface structures.

At 2106, in some implementations, the dispensed fluid may be allowed to flow for a particular period of time, such that the fluid drop achieves the desired shape and/or height. In some implementations, the flow of the dispensed spacer fluid can be governed by one or more confinement gratings that have been created on the surface(s) of the substrate.

At 2108, the spacer fluid can be cured to create the spacers.

At 2110, the various substrates can be stacked to form a waveguide stack in which the gap between stacked waveguides is kept constant over the area of the waveguide and over time, through use of the created spacers.

As described above, in some implementations the curing of the spacer drops can be performed in flight as the drops are dispensed onto the surface of the substrate. In implementations, when the drops are partially cured in-flight, there may be a second curing step that is performed after the drops are placed onto the surface of the substrate. In such examples, multiple drops can be stacked to create spacers of the desired height, as described above.

While this disclosure contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. In addition, the processes depicted in the figures do not necessarily require the particular order shown, or sequential order, to achieve desirable results. In certain implementations, multitasking and parallel processing may be advantageous.

While various implementations of the present invention have been described herein, it should be understood that they have been described as examples. Many variations and modifications may be apparent to those skilled in the art upon reading the specification. The breadth and scope of the present invention is not limited by the examples described herein, and can be interpreted broadly to include such variations and modifications. The described implementations and other such implementations are within the scope of the following claims.

1. A waveguide stack for use in an optical device, the waveguide stack comprising:
a first waveguide configured to convey first light through total internal reflection (TIR); and
a second waveguide configured to convey second light through TIR, wherein the second waveguide includes, on at least one surface of the second waveguide, a plurality of spacers composed of a polymer material that has been dispensed onto the at least one surface and cured, wherein the plurality of spacers are arranged on the at least one surface such that the plurality of spacers are between the second waveguide and the first waveguide in the waveguide stack, and wherein the plurality of spacers each have a respective size to maintain a predetermined separation between the first waveguide and the second waveguide in the waveguide stack.

2. The waveguide stack of claim 1, wherein the second light has a range of wavelengths, and wherein the plurality of spacers are composed of a material that absorbs the second light having the range of wavelengths.

3. The waveguide stack of claim 1, wherein the plurality of spacers are composed of a material that is black.

4. The waveguide stack of claim 1, wherein the plurality of spacers each have a diameter in a range of 10 microns to 200 microns.

5. The waveguide stack of claim 1, wherein the predetermined separation is in a range of 30 microns to 50 microns or 35 microns to 45 microns.

6. The waveguide stack of claim 1, wherein the plurality of spacers inhibits direct contact between the first waveguide and the second waveguide.

7. (canceled)

8. (canceled)

9. (canceled)

10. The waveguide stack of claim 9, wherein the plurality of spacers comprise a dye or pigment selected to absorb all or a portion of light in the visible region.

11. The waveguide stack of claim 1, wherein the plurality of spacers comprise inorganic nanoparticles.

12. (canceled)

13. (canceled)

14. (canceled)

15. The waveguide stack of claim 1, wherein the second waveguide includes, on at least one surface of the second waveguide, one or more optically active regions, and wherein at least one of the plurality of spacers is located in the one or more optically active regions.

16. The waveguide stack of claim 15, wherein the one or more optically active regions include one or more of an exit pupil expander (EPE), an orthogonal pupil expander (OPE), a combined pupil expander (CPE), or an in-coupling grating (ICG).

17. (canceled)

18. The waveguide stack of claim 1, wherein the second waveguide includes, on at least one surface of the second waveguide, at least one confinement region bounded by one or more confinement gratings, and wherein at least one of the plurality of spacers is located in the at least one confinement region.

19. (canceled)

20. The waveguide stack of claim 1, wherein the first and second waveguides are curved.

21. The waveguide stack of claim 1, further comprising a third waveguide configured to convey third light through TIR, wherein the first light has a first range of wavelengths, wherein the second light has a second range of wavelengths different than the first range, and wherein the third light has a third range of wavelengths different than the first range and the second range.

22. (canceled)

23. The waveguide stack of claim 21, wherein the third waveguide includes, on at least one second surface of the third waveguide, a second plurality of spacers composed of the polymer material that has been dispensed onto the at least one second surface and cured, wherein the second plurality of spacers are arranged on the at least one second surface such that the second plurality of spacers are between the third waveguide and the second waveguide in the waveguide stack, and wherein the second plurality of spacers each have a respective size to maintain a predetermined separation between the second waveguide and the third waveguide in the waveguide stack.

24. (canceled)

25. (canceled)

26. (canceled)

27. (canceled)

28. The waveguide stack of claim 1, wherein at least two of the plurality of spacers have different sizes.

29. (canceled)

30. A method of manufacturing a waveguide stack for use in an optical device, the method comprising:
dispensing a plurality of drops of a prepolymer material onto at least one surface of a first waveguide;
curing the drops to form a plurality of spacers from the plurality of drops; and
stacking the first waveguide with a second waveguide to assemble the waveguide stack,
wherein the plurality of spacers are arranged on the at least one surface such that the plurality of spacers are between the second waveguide and the first waveguide in the waveguide stack, and wherein the plurality of spacers each have a respective size to maintain a predetermined separation between the first waveguide and the second waveguide in the waveguide stack.

31. The method of claim 30, wherein the plurality of drops are dispensed from a drop dispenser, and wherein the drops are fully cured after they exit the drop dispenser and before the drops reach the at least one surface.

32. The method of claim 30, wherein the plurality of drops are dispensed from a drop dispenser, and wherein the drops are partially cured after they exit the drop dispenser and before the drops reach the at least one surface.

33. The method of claim 30, wherein the plurality of drops are dispensed from a drop dispenser, and wherein curing the drops comprises:
a first curing in which the drops are partially cured after they exit the drop dispenser and before they reach the at least one surface; and
a second curing in which the drops are fully cured after the drops reach the at least one surface.

34. The method of claim 30, wherein the prepolymer material comprises a dye or pigment selected to absorb all or a portion of light in the visible region, wherein the prepolymer material comprises inorganic nanoparticles.

35. (canceled)

36. (canceled)

37. (canceled)

38. (canceled)

39. (canceled)
